(19) United States
(12) Patent Application Publication
(10) Pub. No.: US 2013/0044713 A1
(43) Pub. Date: Feb. 21, 2013

(54) METHOD AND APPARATUS FOR TRANSMITTING AND RECEIVING RESOURCE ALLOCATION INFORMATION FOR APERIODIC TRANSMISSION OF SOUNDING REFERENCE SIGNAL

(71) Applicants: Sung Jin Suh, Seoul (KR); Sung Kwon Hong, Seoul (KR)

(72) Inventors: Sung Jin Suh, Seoul (KR); Sung Kwon Hong, Seoul (KR)

(73) Assignee: PANTECH CO., LTD., Seoul (KR)

(21) Appl. No.: 13/643,239

(22) PCT Filed: Jun. 20, 2011
(86) PCT No.: PCT/KR11/04491

§ 371 Date: Oct. 24, 2012

(30) Foreign Application Priority Data
Jun. 22, 2010 (KR) 10-2010-0059177
Jun. 25, 2010 (KR) 10-2010-0060845
Oct. 19, 2010 (KR) 10-2010-0102147

(51) Int. Cl. H04W 72/04

(52) U.S. Cl. 370/329

(57) ABSTRACT

A method for transmitting resource allocation information for an aperiodic transmission of a sounding reference signal (SRS) includes: determining, by a base station (BS), resource to be allocated for a transmission of an aperiodic SRS to a user equipment (UE) to which an aperiodic SRS is to be transmitted; transmitting indication information regarding the determined resource by using extra information of a physical control channel; and receiving an aperiodic SRS transmitted by the UE in the determined resource after the transmission of the physical control channel.

### CROSS-REFERENCE TO RELATED APPLICATIONS

This application is the National Stage Entry of International Application No. PCT/KR2011/004491, filed on Jun. 20, 2011 and claims priority from and the benefit of Korean Patent Application Nos. 10-2010-0059177, filed on Jun. 22, 2010, 10-2010-0060845, filed on Jun. 25, 2010, and 10-2010-0102147, filed on Oct. 19, 2010, all of which are hereby incorporated by reference for all purposes as if fully set forth herein.

### BACKGROUND

1. Field

The present invention relates to a wireless communication system and, more particularly, to a method and apparatus for transmitting and receiving resource allocation information for an aperiodic transmission of a control signal for estimating the state of resources.

2. Discussion of the Background

In line with the advancement of communication system, consumers like service providers or individuals use a variety of wireless terminals.

Over current mobile communication systems such as 3GPP, LTE(Long Term Evolution), LTE-A(LTE Advanced), development of a technology which is capable of transmit large capacity data, matching a fixed line communication network, for a high speed, high capacity communication system for transmitting and receiving a variety of data such as image, wireless data, or the like, beyond voice-oriented services, is required, and an appropriate error detection scheme capable of improving system performance by minimizing an information loss and increasing a system transmission efficiency is requisite.

Also, currently, in various communication systems, various control signals are used to provide information regarding a communication environment, or the like, to a counterpart device through uplink or downlink, and in this case, a reference signal, or the like, is used as a control signal.

For example, in an LTE system, one of mobile communication methods, a sounding reference signal is transmitted as a channel estimation reference signal indicating a channel status of a user equipment (UE), a terminal, to a base station (BS) device in an uplink transmission. Meanwhile, in a downlink transmission, a cell-specific reference signal (CRS), a reference signal, is transmitted for each subframe in order to recognize channel information.

In general, the reference signals for a channel estimation, or the like, are periodically generated by a reference signal transmission device. Namely, an uplink reference signal is periodically generated by a terminal and transmitted to a reference signal reception device, and a downlink reference signal is periodically generated by a base station device and transmitted to the reference signal reception device.

A detailed transmission method of an aperiodic channel estimation reference is required.

### SUMMARY

Therefore, an embodiment of the present disclosure provides a technique for transmitting and receiving resource allocation information for aperiodically transmitting a sounding reference signal.

Also, an embodiment of the present disclosure provides an aperiodic transmission technique of a sounding reference signal for estimating a channel status of a terminal.

Also, an embodiment of the present disclosure provides a transmission technique capable of minimizing a collision between a sounding reference signal and a different reference signal by transmitting the sounding reference signal as a multi-shot so as to be aperiodically transmitted.

Also, an embodiment of the present disclosure provides a technique for signaling allocation information of an aperiodic sounding reference signal in order to transmit a multi-shot aperiodic sounding reference signal in an empty resource space.

Also, an embodiment of the present disclosure provides a technique for quickly transferring indication information for controlling a transmission of an aperiodic sounding reference signal to a user terminal.

Also, an embodiment of the present disclosure provides a transmission technique for minimizing the number of transmissions of information for controlling a transmission of an aperiodic sounding reference signal by controlling the aperiodic sounding reference signal such that it is transmitted with a certain period during a certain period of time.

According to an aspect of the present invention, there is provided a method for transmitting resource allocation information for an aperiodic transmission of a sounding reference signal (SRS), including: determining, by a base station (BS), resource to be allocated for a transmission of an aperiodic SRS to a user equipment (UE) to which an aperiodic SRS is to be transmitted; transmitting indication information regarding the determined resource by using extra information of a physical control channel; and receiving an aperiodic SRS transmitted by the UE in the determined resource after the transmission of the physical control channel.

According to another aspect of the present invention, there is provided a method for receiving resource allocation information for an aperiodic transmission of a sounding reference signal (SRS), including: receiving, by a user equipment (UE), a physical control channel from a base station (BS); checking whether information of the received physical control channel is extra information; when the information of the control channel is extra information, converting the information of the physical control channel into indication information indicating resource to be allocated for a transmission of an aperiodic SRS; and transmitting an aperiodic SRS by using the indication information.

According to another aspect of the present invention, there is provided an apparatus for transmitting resource allocation information for an aperiodic transmission of a sounding reference signal (SRS), including: a determining unit configured to determine resource to be allocated for a transmission of an aperiodic SRS to a user equipment (UE) to which an aperiodic SRS is to be transmitted; an indication information generating unit configured to generate indication information indicating the determined resource; a coding unit configured to generate a radio signal by including the indication information in extra information of a physical control channel; and a transceiver unit configured to transmit the radio signal to the UE and receive an aperiodic SRS transmitted by the UE in the determined resource.

According to another aspect of the present invention, there is provided an apparatus for receiving resource allocation information for an aperiodic transmission of a sounding reference signal (SRS), including: a transceiver unit configured to receive radio signal including a physical control channel from a base station (BS) and transmit an SRS; an indication information extracting unit configured to check whether information of the received physical control channel is extra information, and convert the information of the physical control channel into indication information indicating resource to be allocated for a transmission of an aperiodic SRS when the information of the control channel is extra information; and an SRS generating unit configured to generate an aperiodic SRS by using the indication information.

According to another aspect of the present invention, there is provided a method for transmitting a sounding reference signal (SRS) by a user equipment (UE) in a wireless communication system, including: checking a code point expressed by bits of a resource allocation field for a data transmission of a physical downlink control channel (PDCCH); checking whether the value of the checked value of the code point is not within an indication information range for a resource allocation determined according to a pre-set bandwidth; when the value of the code point is not within the indication information range, checking information regarding a starting point for transmitting the SRS and information of a bandwidth for transmitting the SRS through the bits expressing the value of the code point; and transmitting the SRS according to the checked items of information.

According to another aspect of the present invention, there is provided a method for transmitting a sounding reference signal (SRS), including: receiving downlink control information including a mode switch indicating a mode in which a configuration parameter regarding an aperiodic SRS is transmitted, from a base station (BS); determining an interpretation method of the downlink control information based on the mode switch; interpreting the downlink control information according to the determined interpretation method; and performing an uplink transmission on the BS based on the interpreted downlink control information. The mode switch may indicate whether the configuration parameter is included in the downlink control information and transmitted, or transmitted according to upper layer signaling.

According to another aspect of the present invention, there is provided a method for receiving a sounding reference signal (SRS), including: transmitting downlink control information including a mode switch indicating a mode in which a configuration parameter regarding an aperiodic SRS is transmitted, to a terminal; transmitting the configuration parameter; and receiving an uplink signal generated based on the configuration parameter from the terminal. The mode switch may indicate whether the configuration parameter is included in the downlink control information and transmitted, or transmitted according to upper layer signaling.

According to another aspect of the present invention, there is provided an apparatus for transmitting a sounding reference signal (SRS), including: a reception unit configured to receive downlink control information including a mode switch indicating a mode in which a configuration parameter regarding an aperiodic SRS is transmitted, from a base station (BS); a determining unit configured to determine an interpretation method of the downlink control information based on the mode switch and interpret the downlink control information according to the determined interpretation method; and a transmission unit configured to perform an uplink transmission on the BS based on the interpreted downlink control information. The mode switch may indicate whether the configuration parameter is included in the downlink control information and transmitted, or transmitted according to upper layer signaling.

According to another aspect of the present invention, there is provided an apparatus for receiving a sounding reference signal (SRS), including: a transmission unit configured to downlink control information including a mode switch indicating a mode in which a configuration parameter regarding an aperiodic SRS is transmitted, and the configuration parameter to a terminal; and a reception unit configured to receive an uplink signal generated based on the configuration parameter from the terminal. The mode switch may indicate whether the configuration parameter is included in the downlink control information and transmitted, or transmitted according to upper layer signaling.

According to embodiments of the present invention, by using a DCI format 0/1 A, aperiodic SRS transmission is possible without effecting the function of a DCI format 0/1A.

### BRIEF DESCRIPTION OF THE DRAWINGS

FIG. 1 illustrates a wireless communication system to which embodiments of the present invention are applied.

FIG. 2 illustrates a subframe and a time slot structure of transmission data applicable to an embodiment of the present invention, and a general structure of a time-slot according to an embodiment of the present invention.

FIG. 3 shows an example of a periodic SRS transmission in a communication system to which the present embodiment can be applicable.

FIG. 4 shows empty resources generated in the periodic SRS.

FIG. 5 shows an example of a transmission of an SRS as a multi-shot by using empty resources generated in the periodic SRS configuration.

FIG. 6 is a graph showing content of allocating SRS resource by using the foregoing information.

FIG. 7 shows a structure of a format 0 of downlink control information (DCI) provided by a PDCCH according to an embodiment of the present disclosure.

FIG. 8 shows an example of an allocation of SRS resource by using a PDCCH format according to an embodiment of the present disclosure.

FIG. 9 shows an example of determining SRS resource according to periodicity according to an embodiment of the present disclosure.

FIG. 10 shows an example of a format of indicating an allocation of SRS resource by using a PDCCH format 0 according to an embodiment of the present disclosure.

FIG. 11 shows an example of a format of indicating an allocation of SRS resource by using a PDCCH format 0 according to another embodiment of the present disclosure.

FIG. 12 shows an example of an allocation of aperiodic SRS resource according to an embodiment of the present disclosure.

FIG. 13 shows an example of an allocation of aperiodic SRS resource according to another embodiment of the present disclosure.

FIG. 14 shows an example of a format of indicating an allocation of SRS resource by using a PDCCH format 0 according to still another embodiment of the present disclosure.

FIG. 15 shows an example of a format of indicating an allocation of SRS resource by using a PDCCH format 0 according to yet another embodiment of the present disclosure.

FIG. 16 shows an example of allocation of SRS resource to an RA field area of PDCCH format 0 in each bandwidth according to an embodiment of the present disclosure.

FIG. 17 is a how chart illustrating the process of transmitting, by a base station (BS), resource allocation information for an aperiodic transmission of a sounding reference signal to a user equipment (UE) according to an embodiment of the present disclosure.

FIG. 18 is a how chart illustrating the process of receiving, by the UE, resource allocation information for an aperiodic transmission of the sounding reference signal from the BS according to an embodiment of the present disclosure.

FIG. 19 is a how chart illustrating the process of transmitting, by a base station (BS), resource allocation and period information for an aperiodic transmission of a sounding reference signal to a user equipment (UE) according to an embodiment of the present disclosure.

FIG. 20 is a how chart illustrating the process of receiving, by the UE, resource allocation and period information for an aperiodic transmission of the sounding reference signal from the BS according to an embodiment of the present disclosure.

FIG. 21 is a schematic block diagram of a device for transmitting resource allocation information for an aperiodic transmission of a sounding reference signal according to an embodiment of the present disclosure.

FIG. 22 is a schematic block diagram of a device for receiving resource allocation and period information for an aperiodic transmission of a sounding reference signal according to an embodiment of the present disclosure.

FIG. 23 is a schematic block diagram of a device for receiving resource allocation and period information for an aperiodic transmission of a sounding reference signal according to another embodiment of the present disclosure.

FIG. 24 shows indication information indicating an allocation of resource for a periodic transmission of an aperiodic SRS by using a PDCCH format 0 according to an embodiment of the present disclosure.

FIG. 25 shows indication information indicating an allocation of resource for a periodic transmission of an aperiodic SRS by using a PDCCH format 0 according to another embodiment of the present disclosure.

FIG. 26 is a how chart illustrating the process of a method for transmitting ASRS setting parameter by the BS according to an embodiment of the present disclosure.

FIG. 27 is a how chart illustrating the process of a method for receiving an ASRS setting parameter by the UE according to another embodiment of the present invention.

### DETAILED DESCRIPTION OF THE ILLUSTRATED EMBODIMENTS

Embodiments of the present invention will be described below in detail with reference to the accompanying drawings, where those components are rendered the same reference number that are the same or are in correspondence, regardless of the figure number, and redundant explanations are omitted. In describing the present invention, if a detailed explanation for a related known function or construction is considered to unnecessarily divert the gist of the present invention, such explanation has been omitted but would be understood by those skilled in the art.

In describing elements of the present invention, terms such as first, second, A, B, (a), (b), etc. may be used. However, these terms are only used to distinguish one element from another and the essence, sequence, or order of the corresponding elements is not limited by the terminals. It will be understood that when an element is referred to as being “connected with” another element, it can be directly connected with the other element or intervening elements may also be present.

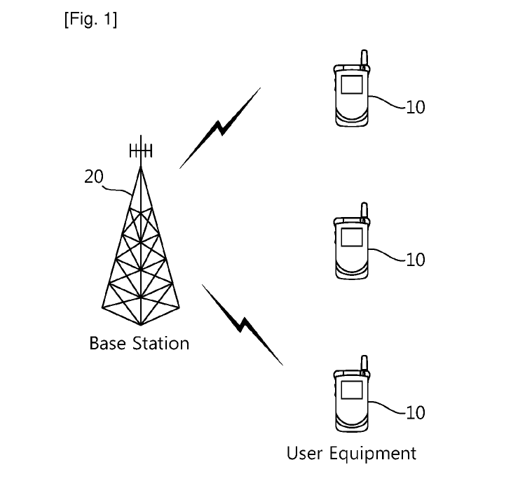

FIG. 1 illustrates a wireless communication system to which embodiments of the present invention are applied.

The wireless communication system is widely disposed to provide various communication services such as voice data, packet, data, or the like.

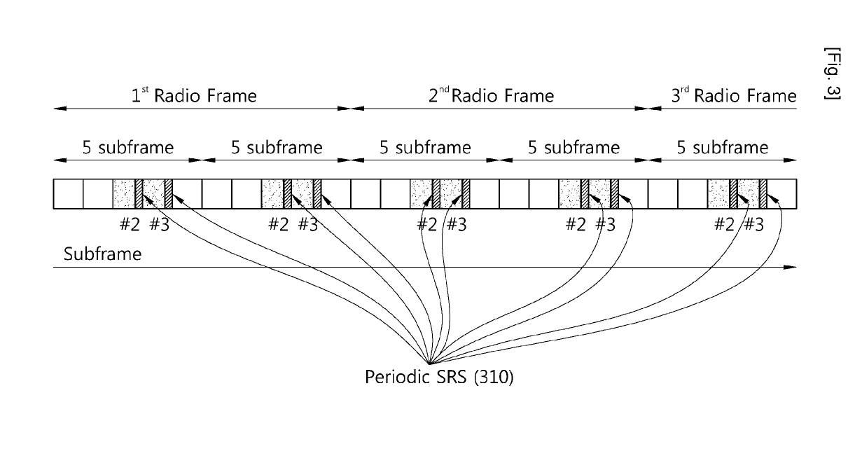

With reference to FIG. 1, the wireless communication system includes a user equipment (UE) 10 and a base station (BS) 20. A technique of generating a reference signal for an extended channel estimation (to be described) is applied to the UE 10 and the BS 20, and this will be described in detail with reference to FIG. 3 and other drawings.

The UE 10 in the present document may be construed to have a concept including all of MS (Mobile Station), UT (User Terminal), SS (Subscriber Station), wireless device, or the like, in GSM, as well as UE in WCDMA, LTE, HSPA, or the like.

The BS 20 or a cell generally refers to a fixed station communicating with the UE 10 and may be called by other names such as Node-B, eNB (evolved Node-B), BTS (Base Transceiver System), access point, relay node, or the like.

Namely, the BS 20 or a cell in the present document may be construed to have a comprehensive meaning indicating an area covered by a BSC (Base Station Controller) in CDMA, a NodeB in WCDMA, or the like, and has a meaning entirely covering various coverage areas such as mega-cell, macro-cell, micro-cell, pico-cell, femto-cell, relay node communication coverage, or the like.

In the present document, the UE 10 and the BS 20, two transmission and reception subjects used for implementing a technique or a technical concept described in the present document, are not limited to a particularly designated term or word.

There is no limitation in multi-access schemes applied to the wireless communication system. Various multi-access schemes such as CDMA (Code Division Multiple Access), TDMA (Time Division Multiple Access), FDMA (Frequency Division Multiple Access), OFDMA (Orthogonal Frequency Division Multiple Access), OFDMFDMA, OFDM-TDMA, OFDM-CDMA may be used.

For an uplink transmission and a downlink transmission, a TDD (Time Division Duplex) allowing for a transmission using a different time may be used, or an FDD (Frequency Division Duplex) allowing for a transmission using a different frequency may be used.

An embodiment of the present invention may be applicable to a resource allocation in asynchronous wireless communication evolving to LTE (Long Term Evolution) and LTE-advanced through GSM, WCDMA, HSP and a synchronous wireless communication field evolving to CDMA, CDMA-2000, and UMB. The present invention may not be construed to be restricted or limited to a particular wireless communication field but be construed to include any technical field to which the concept of the present invention may be applicable.

The wireless communication system to which an embodiment of the present invention is applied may support an uplink and/or downlink HARQ and may use a CQI (channel quality indicator) for a link adaptation. Also, a multi-access scheme for an uplink transmission and that for a downlink transmission may be different. For example, OFDMA (Orthogonal Frequency Division Multiple Access) may be used for a downlink transmission and SC-FDMA (Single Carrier-Frequency Division Multiple Access) may be used for an uplink transmission.

Radio interface protocol layers between a UE and a network may be divided into a first layer (L1), a second layer (L2), and a third layer (L3) based on three lower layers of an open system interconnection (OSI) standard model widely known in communication systems, and a physical layer belonging to the first layer provides an information transfer service using a physical channel.

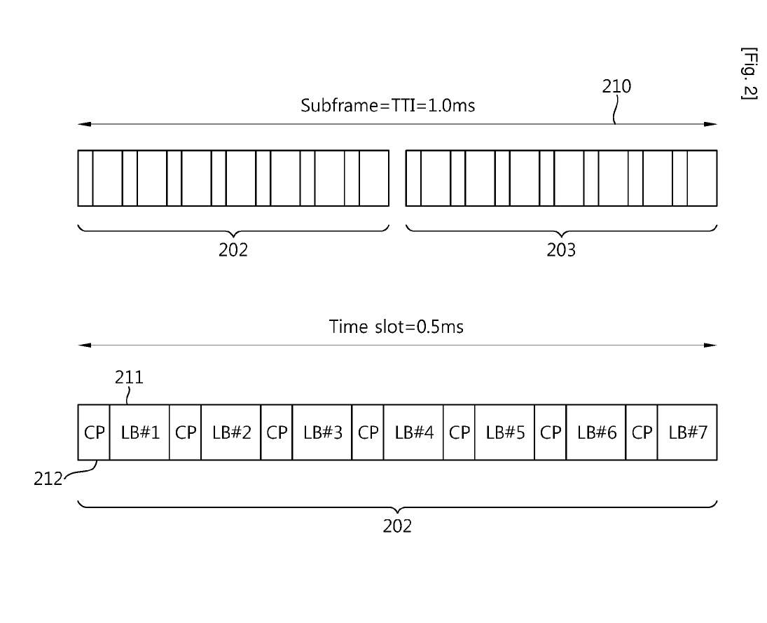

FIG. 2 illustrates a subframe and a time slot structure of transmission data applicable to an embodiment of the present invention, and a general structure of a time-slot according to an embodiment of the present invention.

One radio frame may be composed of ten subframes 210, and one subframe may include two slots 202 and 203. In general, a basic unit of a data transmission is subframe, and downlink or uplink scheduling is performed by subframe.

One slot may include a plurality of OFDM symbols in a time domain and at least one subcarrier in a frequency domain (frequency band). One slot may include seven or six OFDM symbols. For example, when a subframe includes two time slots, each time slot may include seven symbols in the time domain and twelve subcarriers in the frequency domain in the frequency domain. The time-frequency domain defined as one slot may be called a resource block (RB) but it is not limited thereto.

In a 3GPP LTE system, a transmission time of a frame is divided into a transmission time interval (TTI) having duration of 1.0 ms. The term of TTI and subframe may be used to have the same meaning, and a frame has a length of 10 ms and includes ten TTIs.

Reference numeral 202 shows a general structure of a time-slot according to an embodiment of the present invention.

As described above, TTI is a basic transmission unit, one TTI includes two time slots 202 and 203, and each time slot has duration of 0.5 ms.

The time slot 202 includes seven long blocks LBs 211. The LBs 211 are separated by a cyclic prefix 212. Namely, one TTI or one subframe may include fourteen LB symbols, but the present invention is not limited to such a frame, sub-frame, or timeslot structure.

Meanwhile, in the LTE communication system, one of current wireless communication schemes, a demodulation reference signal (DMRS) and a sounding reference signal (SRS) are defined in uplink.

Three types of reference signals (RS) are defined in downlink. The three types of reference signals are a cell-specific reference signal (CRS), an MBSFN-RS (Multicast Broadcast over Single Frequency Network—Reference Signal), and a UE-specific reference signal.

Namely, in the wireless communication system, in order to transfer uplink channel information to a BS, a reference signal for an uplink channel estimation, a sort of reference signal, is transmitted to a single BS. The channel estimation reference signal may include, for example, a sounding reference signal used in LTE (Long Term Evolution) and LTE-Advanced, which has the same function as a pilot channel with respect to an uplink channel.

The process and method for controlling an aperiodic transmission of a control signal will now be described. A channel estimation reference signal as an example of a control signal, and a sounding reference signal (SRS) as an example of the channel estimation reference signal will be largely described, but the present invention is not limited to the SRS or the channel estimation reference signal but includes any types of control signals used in uplink and downlink.

Such an SRS must be able to transfer uplink channel information with respect to the overall area including a band which is likely to be used by each UE as well as a band to be used by each UE, to the BS. Namely, the SRS must be transmitted over the entire subcarrier bands.

According to the current LTE standard, an SRS sequence is generated by Equation 1 shown below, and the generated SRS sequence undergoes resource mapping according to a certain reference and is then transmitted according to a subframe set-up as shown in Table 1 below.

r^{SRS}(n)=r_{u,v}^{(a)}(n)=e^{(janr)}^{^{−}}r_{(u,v)}(n) [Math.1]

0≦n≦M_{sc}^{RS}

Here,

M_{sc}^{RS}=mN_{sc}^{RB}

is the length of a reference sequence,

1≦m≦N_{RB}^{max, UL}

u is a PUCCH sequence group number, v is a base sequence number, and cyclic shift (CS) is

$$α = 2 π \frac{{n}_{SRS}^{cs}}{8} , \\ {n}_{SRS}^{CS}$$

is one of integer values 0 to 7, which is set for each terminal by an upper layer.

TABLE 1

| | | Configuration | Transmission |
|---|---|---|---|
| | | Period T_{SFC} | Offset Δ_{SFC} |
| srsSubframeConfiguration | Binary | (subframes) | (subframes) |
| 0 | 0000 | 1 | {0} |
| 1 | 0001 | 2 | {0} |
| 2 | 0010 | 2 | {1} |
| 3 | 0011 | 5 | {0} |
| 4 | 0100 | 5 | {1} |
| 5 | 0101 | 5 | {2} |
| 6 | 0110 | 5 | {3} |
| 7 | 0111 | 5 | {0, 1} |
| 8 | 1000 | 5 | {2, 3} |
| 9 | 1001 | 10 | {0} |
| 10 | 1010 | 10 | {1} |
| 11 | 1011 | 10 | {2} |
| 12 | 1100 | 10 | {3} |
| 13 | 1101 | 10 | {0, 1, 2, 3, |
| | | | 4, 6, 8} |
| 14 | 1110 | 10 | {0, 1, 2, 3, |
| | | | 4, 5, 6, 8} |
| 15 | 1111 | Inf | N/A |

Table 1 above is a subframe configuration table of a FDD sounding reference signal defined in LTE, in which each format (srsSubframeConfiguration) is defined to have 4 bits, and a transmission period and an offset of an actual transmission subframe are defined for each case. Namely, for example, when the srsSubframeConfiguration value is 8 (1000 in the binary scale), it means that an SRS is transmitted in second and third subframes at every 5 subframes.

FIG. 3 shows an example of a periodic SRS transmission in a communication system to which the present embodiment can be applicable.

For example, FIG. 3 shows a configuration of transmitting an SRS in the second and third subframes at every five subframes when the srsSubframeConfiguration value is 8 (10000 in the binary scale).

Here, the SRS may be transmitted in the last symbol of each subframe. For example, when a subframe is composed of fourteen symbols (in case of a normal cyclic prefix), the SRS is transmitted in the fourteenth symbol, and when a subframe is composed of twelve symbols (in case of extended cyclic prefix), the SRS is transmitted in the twelfth symbol. Of course, the position of the symbol in which the SRS is transmitted is not limited thereto.

According to such an SRS configuration as shown in Table 1 and FIG. 3, the SRS is periodically transmitted in every cell (BS) or in every radio frame or at every transmission period.

In Table 1, when srsSubframeConfiguration is 8, the configuration period is 5 subframes and the transmission offset is 2 and 3.

FIG. 3 shows the case in which the SRS 310 is transmitted in the last symbols of the second and third subframes in every five subframes.

Meanwhile, in transmitting the SRS, the size of a bandwidth for transmitting the SRS is required to be configured. Table 2 below shows corresponding configuration information.

TABLE 2

| | SRS- | | SRS- | | SRS- | | SRS- | |
|---|---|---|---|---|---|---|---|---|
| SRS | Band- | | Band- | | Band- | | Band- | |
| bandwidth | width | | width | | width | | width | |
| Configuration | B_{SRS} = 0 | | B_{SRS} = 1 | | B_{SRS} = 2 | | B_{SRS} = 3 | |
| C_{SRS} | m_{SRS,0} | N₀ | m_{SRS,1} | N₁ | m_{SRS,2} | N₂ | m_{SRS,3} | N₃ |
| 0 | 96 | 1 | 48 | 2 | 24 | 2 | 4 | 6 |
| 1 | 96 | 1 | 32 | 3 | 16 | 2 | 4 | 4 |
| 2 | 80 | 1 | 40 | 2 | 20 | 2 | 4 | 5 |
| 3 | 72 | 1 | 24 | 3 | 12 | 2 | 4 | 3 |
| 4 | 64 | 1 | 32 | 2 | 16 | 2 | 4 | 4 |
| 5 | 60 | 1 | 20 | 3 | 4 | 5 | 4 | 1 |
| 6 | 48 | 1 | 24 | 2 | 12 | 2 | 4 | 3 |
| 7 | 48 | 1 | 16 | 3 | 8 | 2 | 4 | 2 |

Table 2 shows an SRS bandwidth (BW) configuration. When the bandwidth BW of the overall system is in 80 RB (Resource Block)<system BW≦100 RB (Resource Block), the configuration of Table 2 may be used.

Here, C_{SRS} (SRS BW configuration parameter), cell-specific information, is a 3-bit parameter, and B_{SRS} (SRS BW parameter), UE-specific information, is a 2-bit parameter.

Thus, when C_{SRS}=0, B_{SRS}=1, a user of the corresponding cell can have 48 RBs, among the entire 96 RBs, for the SRS BW. Whether to transmit the SRS in the upper 48 RBs or the lower 48 RBs of the 96 RBs may be determined by an SRS start position coming down through RRC signaling. The SRS start position is comprised of 5 bits, and the overall system BW may be divided into maximum 24 equal parts to express each position.

Besides Table 2, the SRS bandwidth may be determined according to bandwidths of the system as shown in Table 3, 4, and 5.

TABLE 3

| | SRS- | | SRS- | | SRS- | | SRS- | |
|---|---|---|---|---|---|---|---|---|
| SRS | Band- | | Band- | | Band- | | Band- | |
| bandwidth | width | | width | | width | | width | |
| Configuration | B_{SRS} = 0 | | B_{SRS} = 1 | | B_{SRS} = 2 | | B_{SRS} = 3 | |
| C_{SRS} | m_{SRS,0} | N₀ | m_{SRS,1} | N₁ | m_{SRS,2} | N₂ | m_{SRS,3} | N₃ |
| 0 | 36 | 1 | 12 | 3 | 4 | 3 | 4 | 1 |
| 1 | 32 | 1 | 16 | 2 | 8 | 2 | 4 | 2 |
| 2 | 24 | 1 | 4 | 6 | 4 | 1 | 4 | 1 |
| 3 | 20 | 1 | 4 | 5 | 4 | 1 | 4 | 1 |
| 4 | 16 | 1 | 4 | 4 | 4 | 1 | 4 | 1 |
| 5 | 12 | 1 | 4 | 3 | 4 | 1 | 4 | 1 |
| 6 | 8 | 1 | 4 | 2 | 4 | 1 | 4 | 1 |
| 7 | 4 | 1 | 4 | 1 | 4 | 1 | 4 | 1 |

Table 3 show configuration information when 6 RB≦overall system bandwidth≦40 RB

TABLE 4

| | SRS- | | SRS- | | SRS- | | SRS- | |
|---|---|---|---|---|---|---|---|---|
| SRS | Band- | | Band | | Band- | | Band | |
| bandwidth | width | | width | | width | | width | |
| Configuration | B_{SRS} = 0 | | B_{SRS} = 1 | | B_{SRS} = 2 | | B_{SRS} = 3 | |
| C_{SRS} | m_{SRS,0} | N₀ | m_{SRS,1} | N₁ | m_{SRS,2} | N₂ | m_{SRS,3} | N₃ |
| 0 | 48 | 1 | 24 | 2 | 12 | 2 | 4 | 3 |
| 1 | 48 | 1 | 16 | 3 | 8 | 2 | 4 | 2 |
| 2 | 40 | 1 | 20 | 2 | 4 | 5 | 4 | 1 |
| 3 | 36 | 1 | 12 | 3 | 4 | 3 | 4 | 1 |
| 4 | 32 | 1 | 16 | 2 | 8 | 2 | 4 | 2 |
| 5 | 24 | 1 | 4 | 6 | 4 | 1 | 4 | 1 |
| 6 | 20 | 1 | 4 | 5 | 4 | 1 | 4 | 1 |
| 7 | 16 | 1 | 4 | 4 | 4 | 1 | 4 | 1 |

Table 4 show configuration information when 40 RB≦overall system bandwidth≦60 RB.

TABLE 5

| | SRS- | | SRS- | | SRS- | | SRS- | |
|---|---|---|---|---|---|---|---|---|
| SRS | Band- | | Band- | | Band- | | Band- | |
| bandwidth | width | | width | | width | | width | |
| Configuration | B_{SRS} = 0 | | B_{SRS} = 1 | | B_{SRS} = 2 | | B_{SRS} = 3 | |
| C_{SRS} | m_{SRS,0} | N₀ | m_{SRS,1} | N₁ | m_{SRS,2} | N₂ | m_{SRS,3} | N₃ |
| 0 | 72 | 1 | 24 | 3 | 12 | 2 | 4 | 3 |
| 1 | 64 | 1 | 32 | 2 | 16 | 2 | 4 | 4 |
| 2 | 60 | 1 | 20 | 3 | 4 | 5 | 4 | 1 |
| 3 | 48 | 1 | 24 | 2 | 12 | 2 | 4 | 3 |
| 4 | 48 | 1 | 16 | 3 | 8 | 2 | 4 | 2 |
| 5 | 40 | 1 | 20 | 2 | 4 | 5 | 4 | 1 |
| 6 | 36 | 1 | 12 | 3 | 4 | 3 | 4 | 1 |
| 7 | 32 | 1 | 16 | 2 | 8 | 2 | 4 | 2 |

Table 5 show configuration information when 60 RB<overall system bandwidth≦80 RB.

M_{sc,b}^{RS}=m_{SRS,b}N_{sc}^{RB}/2

b=B_{SRS} [Math.2]

Meanwhile, as the number of antennas increases like multi-input multi-output (MIMO) and as a communication system which is required to transmit and receive a reference signal to and from a neighbor cell, as well as to and from a serving cell, with which the corresponding user currently performs main transmission and reception like a cooperative multi-point Tx/Rx system (CoMP), or the like, has emerged, in line with the evolution of communication systems, it is difficult to obtain a sufficient SRS capacitor with the periodic SRS transmission scheme, and as a result, the SRS capacitor is required to be extended.

Namely, a communication system is required to aperiodically adjust the SRS which is periodically transmitted in a format determined for each cell, to thus increase scheduling flexibility of the SRS and improve the SRS capacitor.

Meanwhile, various methods have been presented to transmit the aperiodic SRS, and among them is a scheme of sounding an overall frequency band by using resource of an empty space besides the periodic SRS. Namely, it means an aperiodic one-shot SRS scheme for performing sounding on the overall bandwidth at a time.

Meanwhile, there is an aperiodic multi-shot SRS scheme for performing sounding by using an empty space, besides the periodic SRS, several times to complete sounding with respect to the overall band. In addition, various other schemes such as an SRS transmission through a DM-RS area, an SRS transmission using a PUSCH area, and the like, may be implemented.

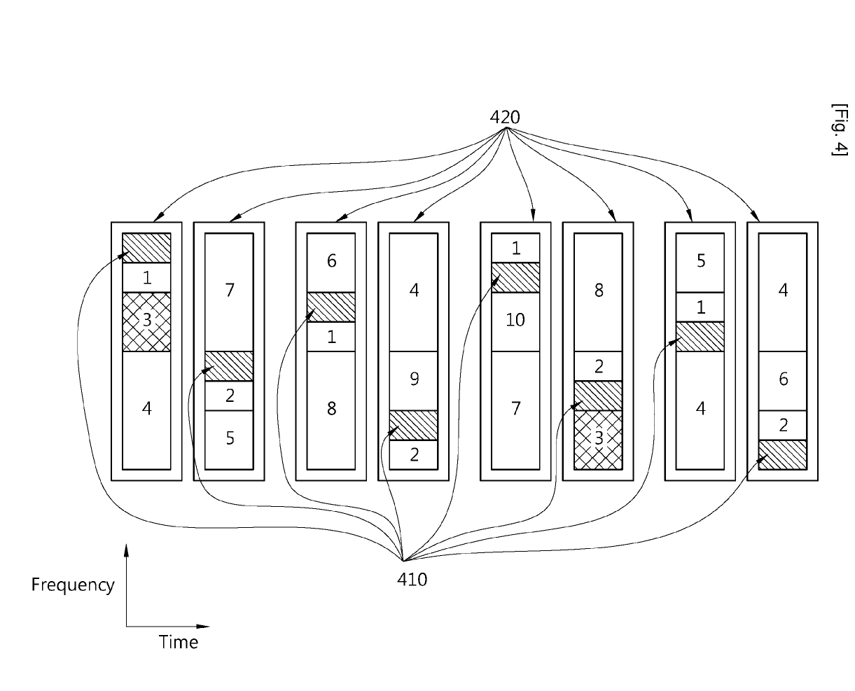

FIG. 4 shows empty resources generated in the periodic SRS. The vertical axis is the frequency domain and the width is a time axis. Numbers in resources are identification information of user terminals to which resources have been allocated.

In FIG. 4, empty resources 410 generated in the process of configuring the periodic SRS 420, and in this case, one resource may be allocated only to one user.

Of course, in case in which different cyclic shifts (CSs) are used for the same resource or different combs are applied to the same resource, when sixteen users transmit the SRSs, empty resource may be allocated to UEs smaller than the number of a maximum allocation number of UEs. When a user is not allocated to a particular resource in a certain resource allocation pattern, empty resources as shown in FIG. 4 may appear.

FIG. 5 shows an example of a transmission of an SRS as a multi-shot by using empty resources generated in the periodic SRS configuration.

With reference to FIG. 5, a UE 3 transmits multi-shot aperiodic SRSs indicated by 530 in the areas of the empty resources 410 in FIG. 4 as mentioned above. The UE 3 can perform sounding on the bandwidth of the overall system through 5 times of transmission. Namely, when where are empty resources which have not been allocated to users, the user, who are to be allocated aperiodic SRSs, may be allocated the resources of the empty spaces from the BS and transmit the multi-shot aperiodic SRSs by using the allocated resources. There are still unused areas 510 among the areas of the empty resources 410 in FIG. 4.

Meanwhile, information required for the periodic SRS may be checked through information regarding a starting point of the SRS resource, C_{SRS} (3 bit) and B_{SRS} (2 bit) described above in the examples of Table 2, 3, and 4 showing the sizes of SRS bandwidths, and a bandwidth size of the SRS allocated with 5 bits. Among these parameters, C_{SRS} (3 bit) is cell-specific information (or a cell-specific parameter) and B_{SRS} (2 bit) is UE-specific information (or a UE-specific parameter).

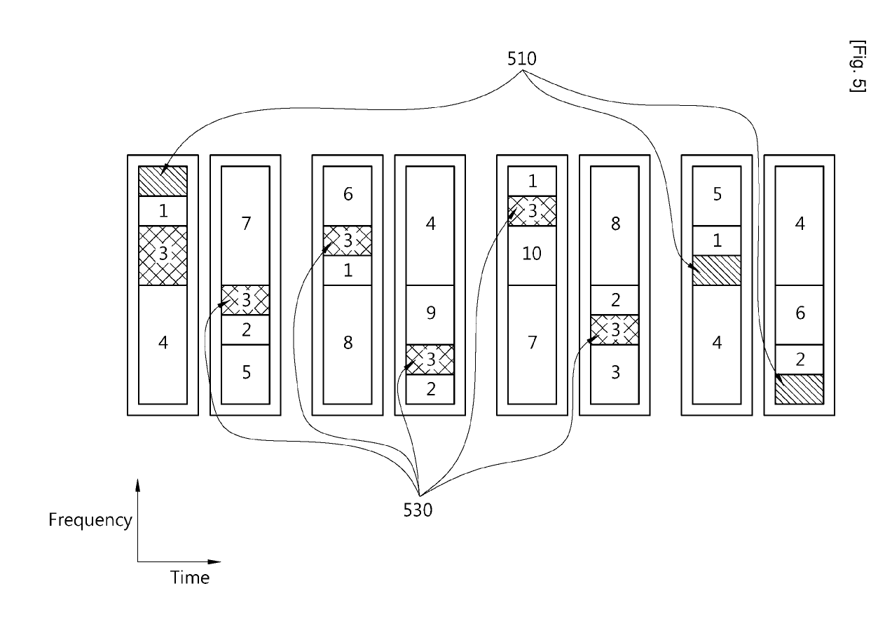

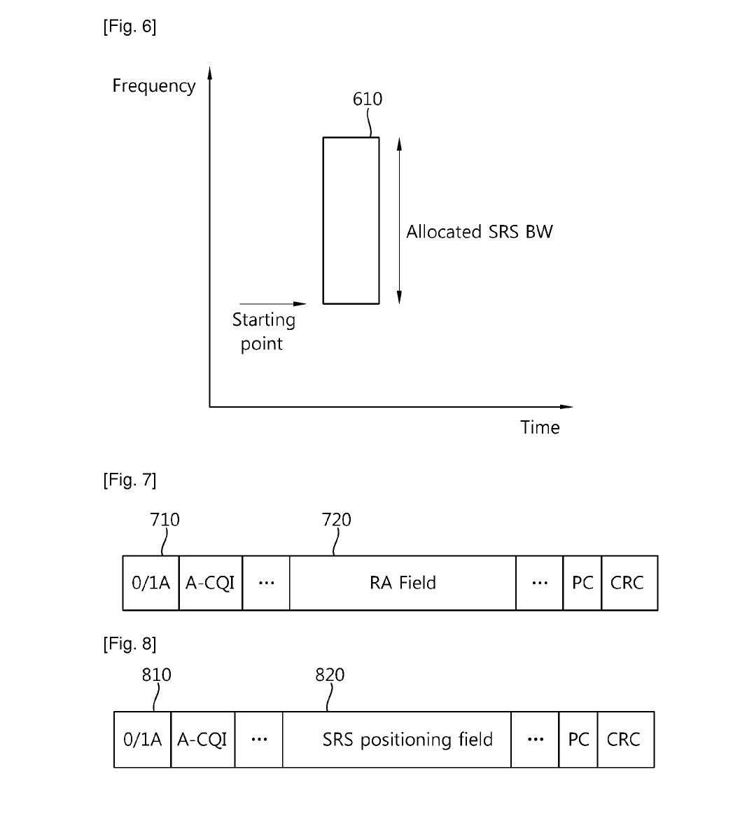

FIG. 6 is a graph showing content of allocating SRS resource by using the foregoing information.

With reference to FIG. 6, 610 is resource by which a particular UE can transmit an SRS. This resource specifies a certain frequency point and a certain bandwidth based on which the SRS is to be transmitted.

A start position of the SRS resource is indicated by a starting point comprised of 5 bits, and the allocated SRS bandwidth may be expressed by using 5 bits of C_{SRS} (3 bit) and B_{SRS} (2 bit) of Table 2, 3, 4, and 5 showing the SRS bandwidth. Among the two types of parameters, C_{SRS} is a cell-specific parameter) and B_{SRS} is a UE-specific parameter.

As discussed above, in order for the UE to be allocated SRS resources, the UE may receive information regarding 5 bits informing about the starting point according to upper layer signaling may determine the bandwidth for transmitting SRS by using the information of Table 2, 3, 4, and 5.

Accordingly, by informing the UE, that is to use the SRS transmitted as multi-shot, about the three parameters (starting point, C_{SRS}, and B_{SRS}), the resources for transmitting the SRS as multi-shot can be indicated.

The three types of parameters (starting point, C_{SRS}, and B_{SRS}) require 5 bits, 3 bits, and 2 bits, respectively, and space of a total of 10 bits is required.

When the starting point and the bandwidths BW(C_{SRS}, B_{SRS}) of the SRS are determined, the other remaining SRS resources may be determined by SRS periodicity and a hopping pattern.

Thus, the SRS may be controlled to be transmitted by using predetermined empty resource temporarily (i.e., randomly as required without having a particular period) according to an embodiment of the present invention. Of course, such a transmission may be included in the category of the aperiodic SRS or the category of the temporary periodic SRS.

The process of providing SRS resource allocation information to allow for an SRS as a multi-shot during a certain period of time, e.g., the period of one or more subframes, and signaling for a resource allocation will now be described.

When empty resources are estimated in order to transmit an SRS as a multi-shot during a certain period of time with a shorter period than the period for controlling the periodic SRS transmission, the empty resources may be configured to have a certain pattern. Namely, when information regarding a start portion of empty resource is provided, the UE may then calculate at which point and at which position the SRS can be transmitted.

In an embodiment of the present document, the three parameters (starting point, C_{SRS}, and B_{SRS}) required for configuring SRS resources for transmitting the periodic SRS are used.

The three parameters (starting point, C_{SRS}, and B_{SRS}) are 5-bit, 3-bit, and 2-bit information, respectively, totaling a length of 10 bits. The amount of such information may be reduced according to a network environment and the amount of sharing information between the UE and the BS. For example, in case of C_{SRS} having a particular value for each cell, since it is information previously secured by the UE in the process of transmitting the periodic SRS and commonly used in the corresponding cell although the BS does not inform the UE about that, the UE may not include it in the SRS resource allocation information unless it is changed.

Also, the aperiodic SRS has such an attribute that it is to be urgently made according to a network situation, so the aperiodic SRS must be quickly controlled. Thus, an embodiment in which resource allocation information for controlling the aperiodic SRS is transmitted via a PDCCH (Physical Downlink Control CHannel) will now be described.

FIG. 7 shows a structure of a format 0 of downlink control information (DCI) provided by a PDCCH according to an embodiment of the present disclosure.

With reference to FIG. 7, order of the field constituting the format 0 is arbitrarily determined. In the format, an RA (Resource Allocation) field 720 positioned at the center is a resource allocation field of allocating resource of PUSCH (Physical Uplink Shared CHannel).

The format 0 includes information for controlling scheduling of the PUSCH. Here, a 0/1 A field includes 1-bit information for discriminating the format 0 and a format 1A. Since the format 0 and the format 1A have the same length, so the format 0/1 A field is used to discriminate the format 0 from the format 1A. An A-CQI field includes information for requesting a CQI (Channel Quality Indicator).

Meanwhile, the RA field provides information regarding a resource block (RB) to be allocated in the PUSCH, which may vary depending on bandwidth.

For example, since the RA field indicates a resource block
N_{RB}^{UL}

is 100 RBs in a bandwidth of 20 MHz, 13 bits

┌ log₂(N_{RB}^{UL}(N_{RB}^{UL}+1)/2)┐

are required to indicate the RA field. In case of 15 MHz, since
N_{RB}^{UL}

is 75 RBs, 12 bits are required. In case of 10 MHz, since
N_{RB}^{UL}

is 50 RBs, 11 bits are required. In case of 5 MHz, since
N_{RB}^{UL}

is 15 RBs, so 7 bits are required.

Hereinafter, a case in which
N_{RB}^{UL}

is 100 RBs in the bandwidth of 20 MHz and 13 bits are allocated to the RA field 720 will now be described.

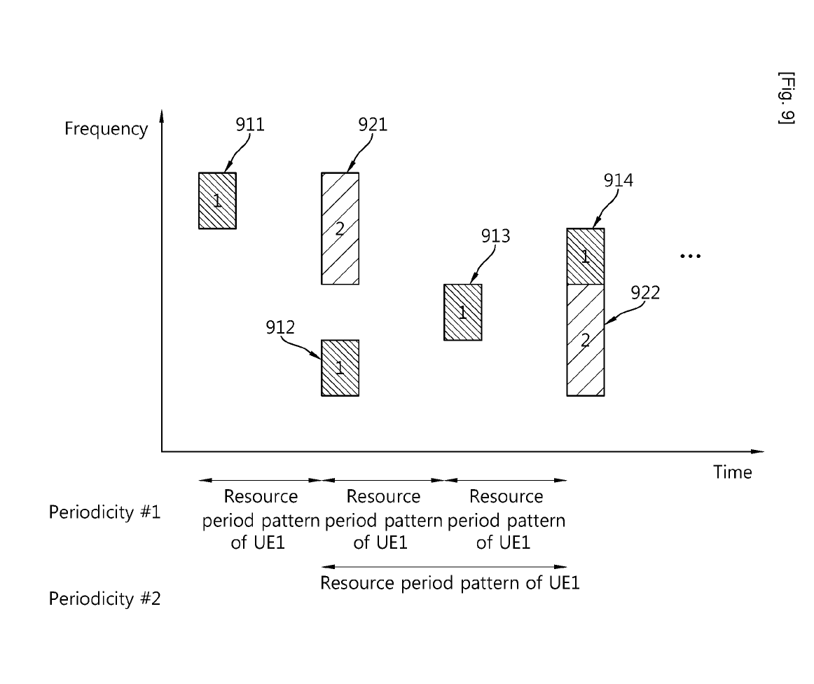

FIG. 8 shows an example of an allocation of SRS resource by using a PDCCH format according to an embodiment of the present disclosure. Specifically, FIG. 8 shows the case in which information required for configuring SRS resource is included through a PDCCH.

With reference to FIG. 8, the length of the PDCCH format 0/1 A as described above with reference to FIG. 7 is used as it is. In case of the bandwidth of 20 MHz in FIG. 7,
N_{RB}^{UL}

is 100 RBs and 13 bits are allocated to the RA field 720. The 13-bit area is used for allocating resource blocks to the UE, and the actually allocated values ranges from 0 to 5049. Meanwhile, information which can be expressed by 13 bits ranges from 0 to 8191. Namely, since values not used in the RA field ranges from 5050 to 8191, the unused values may be used for a resource allocation of the SRS.

Namely, FIG. 8 shows an example of indicating positioning information (SRS positioning) for allocating SRS resource by using the existing PDCCH format 0 used for the uplink grant, without increasing PDCCH overhead or without increasing a blind decoding level. Thus, since the existing RA field of the PDCCH is used, complexity in PDCCH decoding cannot be increased.

Also, in the present embodiment, in order to use the RA field as an SRS positioning field, the range of values not used in the RA field may be used. As mentioned above, 5051 to 8191 are the range of unused values, and this range can express about 11-bit information. Thus, when the size of the value included in the RA field is smaller than

5050, the UE may confirm that the value will be used as the RA field, and when the value is 5050 or greater, the UE may map the value to a certain value of 11 bits to use it as information of an SRS resource allocation.

Namely, in the scheme of designating an SRS BW, since it is greater than the unit of resources to be actually allocated to the user, the BW of the SRS resources can be expressed with bits smaller than the bit information of the existing RA, BW for the SRS can be designated by using the remaining code points in the current format 0.

Thus, for a user for which resources are allocated for every subframe, without using SPS (Semi Persistent Scheduling), when the DCI format 0 designating SRS BW for an aperiodic SRS comes down in order to prevent an unnecessary increase in the PDCCH, the DCI format 0 may be recognized as a resource allocation for an SRS, rather than a resource allocation for an actual data transmission, and resource which has been allocated in a previous subframe may be used as it is as resource for data.

For example, the RA field coming down with the DCI format 0 in the 20 MHz (100 RBs) has 13-bit information. However, as mentioned above, only values smaller than 5050 used for the RA allocation, so when a remaining value ranging from 5050 to 8191 (about 11 bits), exceeding the actual RA field value (0 to 5049) is designated, it may be determined as an SRS resource allocation. Since a minimum unit of BW used for the SRS transmission is 4 RBs, BW required for the SRS transmission can be sufficiently designated in the 100-RB band only with the 9-bit information.

Here, when 11 bits are used as indication information for allocating SRS resource, it can express all of the starting point (5 bits), C_{SRS} (3 bits), and B_{SRS} (2 bits), the parameters required for allocating the SRS resource. Meanwhile, in the bandwidth smaller than 20 MHz, the length of the PDCCH format 0 may be reduced and the amount of available information may be reduced. Namely, the information allocated as the RA field, the available information, and the information for securing SRS resources therethrough are as shown in Table 6 below.

TABLE 6

| | | | | Range (B) | | |
|---|---|---|---|---|---|---|
| | | Range of | | Which can | | Extra |
| | Resource | indication | | be | | range |
| Band- | block | infor- | RA | expressed | Extra | (B − A) is |
| width | (RG, | mation | Field | by RA | Range | converted |
| (MHz) | N_{RB}^{UL}) | (A) | (bit) | field | (B − A) | into bit |
| 20 | 100 | 5050 | 13 | 8192 | 3142 | 11 |
| 15 | 75 | 2850 | 12 | 4096 | 1246 | 10 |
| 10 | 50 | 1275 | 11 | 2048 | 773 | 9 |
| 5 | 25 | 325 | 9 | 512 | 187 | 7 |

Table 6 shows setting of RA values of the PDCCH format 0.

Resource blocks allocated in 5 MHz, 10 MHz, 15 MHz, and 20 MHz are 25, 50, 75, and 100, respectively, and the number required for indicating these resource blocks (i.e., the numbers of indication information, A) are 326, 1275, 2850, and 5050. Meanwhile, values required for indicating the indication information into binary numbers may be calculated by using

┌ log₂(N_{RB}^{UL}(N_{RB}^{UL}+1)/2)┐

and as a result, 9 bits, 11 bits, 12 bits, and 13 bits are allocated to the RA field in 5 MHz, 10 MHz, 15 MHz, and 20 MHz. respectively.

Meanwhile, the sizes of information which can be actually expressed by using such bits (the range B which can be expressed by the RA field) are 512, 2048, 4096, and 8192, which are the multiplications of 2 by nine, eleven, twelve, and thirteen, respectively.

Thus, the range (extra range B-A) of the values not used in the RA field is 187, 773, 1246, and 3142, which may be converted into 7 bits, 9 bits, 10 bits, and 11 bits, respectively, as the amount of available information. Namely, when 7 bits are used, SRS resource allocation indication information, which does not collide with the RA set value of the RA field in any bandwidth can be provided.

Among the three parameters required for allocating the SRS as mentioned above, the starting point (5 bits), C_{SRS} (3 bits), and B_{SRS} (2 bits) total 10 bits. In this case, since 10 MHz and 5 MHz have extra 9 bits and 7 bits, respectively, 10 bits are not sufficient to be used.

Meanwhile, since the value, C_{SRS} (3 bits), common to cells is shared by all the UEs, so this value is not required to be transmitted. Thus, when the starting point (5 bits) and B_{SRS} (2 bits) are indicated in order to allocate SRS resource, only 7 bits may be used, and also in case of 5 MHz, a value discriminated from the RA field may be set. Namely, the resource (BW) of the aperiodic SRS can be allocated only with the remaining code points of the maximum 7 bits.

In another embodiment of this disclosure, the process of providing SRS resource allocation information for transmitting the SRS as a multi-shot during a certain period by using the three types of parameters (the starting point, C_{SRS}, and B_{SRS}) and periodicity required for configuring SRS resource for the periodic SRS transmission and signaling for resource allocation will now be described in detail.

The four types of parameters (the starting point, C_{SRS}, B_{SRS}, and period) are 5 bits, 3 bits, 2 bits, and 10 bits, respectively, but for the aperiodic SRS transmission, the periodicity information may be reduced. Namely, only a portion of 10 bits of the periodicity information, rather than the entirety, may be used. Hereinafter, as noted in Table 7 shown below, information related to a transmission period and offset information are combined. Since the aperiodic SRS is transmitted after the aperiodic SRS resource and the period are allocated, offset information may not be provided. Namely, the amount of information may be reduced according to a network environment and the amount of information shared by the UE and the BS. For example, in case of C_{SRS} having a particular value for each cell, since it is information previously secured by the UE in the process of transmitting the periodic SRS and commonly used in the corresponding cell although the BS does not inform the UE about that, the UE may not include it in the SRS resource allocation information unless it is changed. Also, when the bandwidth for transmitting the aperiodic SRS is used as it is, although BSRS is not provided, the UE can calculate it.

FIG. 9 shows an example of determining SRS resource according to periodicity according to an embodiment of the present disclosure.

With reference to FIG. 9, reference numerals 911, 912, 913, and 914 denote resource areas in which a UE 1 transmits SRS, and 921 and 922 denote resource areas in which a UE 2 transmits SRS. It is noted that SRS periodicity of the UE₁ and that of the UE₂ are different.

When bandwidth BW is determined with the starting point (5 bits), C_{SR}s (3 bits), and B_{SR}s (2 bits), the following resource is determined by the periodicity and frequency hopping pattern. The hopping pattern may be determined by using a cell-specific parameter, a subframe number, and the like. Information related to the SRS periodicity is defined as 10 bits. This is shown in Table 7 below.

TABLE 7

| SRS Configuration | SRS Periodicity | SRS Subframe |
|---|---|---|
| Index I_{SRS} | T_{SRS} (ms) | Offset T_{offset} |
| 0-1 | 2 | I_{SRS} |
| 2-6 | 5 | I_{SRS} -2 |
| 7-16 | 10 | I_{SRS} -7 |
| 17-36 | 20 | I_{SRS} -17 |
| 37-76 | 40 | I_{SRS} -37 |
| 77-156 | 80 | I_{SRS} -77 |
| 157-316 | 160 | I_{SRS} -157 |
| 317-636 | 320 | I_{SRS} -317 |
| 637-1023 | reserved | reserved |

Table 7 shows periodicity and corresponding offset information in allocating SRS resource. In FIG. 7, eight types of periodicity (2 ms, 5 ms, 10 ms, 20 ms, 40 ms, 80 ms, 160 ms, 320 ms) are provided. Since there are eight types of periodicity, 3 bits are required to discriminate each periodicity, but information of a total of 10 bits is required in order to provide the offset information regarding each periodicity.

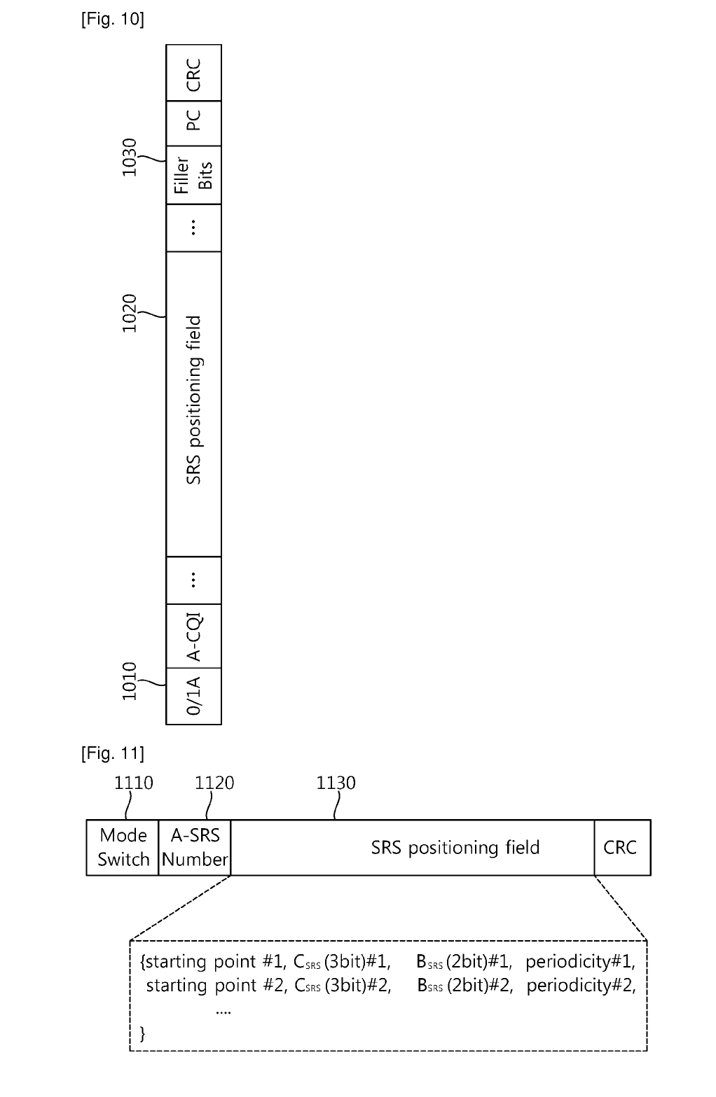

FIG. 10 shows an example of a format of indicating an allocation of SRS resource by using a PDCCH format 0 according to an embodiment of the present disclosure.

FIG. 10 shows a PDCCH format including an SRS positioning field. The format 0 includes information for controlling scheduling of the PUSCH. Reference numeral 1010 is 1-bit information for discriminating format 0 and format 1A. Since the format 0 and the format 1A have the same length, they are required to be discriminated. A-CQI is information for requesting a CQI (Channel Quality Indicator). Reference numeral 1020 may be used as a field for SRS positioning when aperiodic SRS is required by using a resource allocation field using the PUSCH in the existing uplink grant format. The resource allocation field using the PUSCH presents information regarding a resource block to be allocated in the PUSCH, which varies depending on bandwidth. Since the resource allocation field indicates a resource block and
N_{RB}^{UL}

is 100 RBs in a bandwidth of 20 MHz, 13 bits

┌ log₂(N_{RB}^{UL}(N_{RB}^{UL}+1)/2)┐

are required to indicate the RA field. In case of 15 MHz, since
N_{RB}^{UL}

is 75 RBs, 12 bits are required. In case of 10 MHz, since
N_{RB}^{UL}

is 50 RBs, 11 bits are required. In case of 5 MHz, since
N_{RB}^{UL}

is 15 RBs, so 7 bits are required. Meanwhile, the range of values of the resource allocation field using the PUSCH is equal to ‘A’ in Table 6, so the SRS resource allocation and period information (periodicity) can be provided by using the extra value and the filler bits 1030.

Information regarding the position and band of SRS resource can be indicated by using the existing PDCCH format 0 used for the uplink allocation, without increasing PDCCH overhead or without increasing a blind decoding level. In the process of decoding the PDCCH, reference numeral 1020 uses the existing RA field of the PDCCH, which means that an extra value not used in the RA field is used for designating an SRS bandwidth.

Namely, in the scheme of designating an SRS bandwidth, since it is greater than the unit of resources to be actually allocated to the user, the bandwidth of the SRS resources can be designated with bits smaller than the bit information of the existing RA, BW for the SRS can be designated by using the remaining code points in the current format 0.

Thus, for a user for which resources are allocated for every subframe, without using SPS (Semi Persistent Scheduling), when the DCI format 0 designating SRS BW for an aperiodic SRS comes down in order to prevent an unnecessary increase in the PDCCH, the DCI format 0 may be recognized as a resource allocation for an SRS, rather than a resource allocation for an actual data transmission, and resource which has been allocated in a previous subframe may be used as it is as resource for data.

In case of the user who is allocated through SPS (Semi-statistic scheduling), he uses the previously scheduled RA field as it is. In this case, however, when new scheduling is performed by the A-SRS, the SPS may be reset.

For example, the RA field coming down with the DCI format 0 in a 20 MHz (100 RBs) has 13-bit information. However, since the actually used codes (the range A of indication information) is 0 to 5049 as shown in Table 8 below, the remaining code points (extra range B-A, which is about 11 bits) from 5050 to 8191 can be used. Since a minimum unit of bandwidth used for the SRS transmission is 4 RBs, so the bandwidth (BW) required for the SRS transmission can be sufficiently designated in the 100 RB band only with the 9-bit information. Thus, this can be expressed within the remaining code points (11 bits).

Namely, in case of 20 MHz, since the code points are 11 bits, they are not sufficient to express all of the starting point (5 bits), C_{SRS} (3 bits), B_{SRS} (2 bits), and SRS periodicity (10 bits). However, a parameter which is already recognized by the UE or a parameter which is not required to be transferred may be excluded. For example, in case of C_{SRS} (3 bits), since it is a cell-specific parameter, all the users within the corresponding cell share the common value. Thus, the C_{SRS} is not required to be separately indicated on the same assumption for the aperiodic SRS. Also, in case of B_{SRS} (2 bits), when SRS is transmitted by using aperiodic SRS and the corresponding user uses the B_{SRS} (2 bits) value determined for the existing periodic SRS as it is, the user does not need to set B_{SRS} (2 bits). Namely, the UE can ascertain the bandwidth of the aperiodic SRS by using the previous value without having to receive the B_{SRS} (2 bits) value for the aperiodic SRS. However, since the resource of aperiodic SRS which can be allocated in one subframe has the same size as the resource of the periodic SRS, flexibility is lowered. In this case, however, the number of transmissions may be increased to offset the reduced flexibility. Meanwhile, in case of SRS periodicity (10 bits), the periodicity of aperiodic SRS can be expressed only with 3 bits as shown in Table 7. The reason is because eight types of information regarding the SRS periodicity, i.e., 2 ms, 5 ms, 10 ms, 20 ms, 40 ms, 80 ms, 160 ms, and 320 ms, exist as shown in Table 7. Since the aperiodic SRS can be transmitted at a necessary point in time by using the uplink grant format, so there is no need to indicate even subframe offset information of Table 7. Thus, the periodicity required for the aperiodic SRS transmission can be expressed with 3 bits.

Thus, in order to allocate resource required for the transmission of the aperiodic SRS providing periodicity, it may be indicated through the information (5 bits) regarding the starting point and the information (3 bits) regarding the periodicity.

Meanwhile, bits which can use the extra range of the RA field in 5 MHz, 10 MHz, 15 MHz, and 20 MHz in Table 6 are 7 bits, 9 bits, 10 bits, and 11 bits, respectively. However, as shown in FIG. 10, there are filler bits in the PDCCH format 0, which are used to adjust the size of the PDCCH format 0 and format 1 A. Thus, when the RA field and the filter bits are combined for SRS positioning, bits which can use extra range of the RA field in 5 MHz, 10 MHz, 15 MHz, and 20 MHz are 8 bits, 10 bits, 11 bits, and 12 bits, respectively, and these bits may be used to set the starting point (5 bits) for the SRS resource allocation and the periodicity information (3 bits) regarding the aperiodic SRS to transmit the parameter required for positioning of the aperiodic SRS.

The foregoing configuration is also available in the format 1A. Since the format 0 and the format 1A have the same RA field and have the same size, except for the difference in the uplink/downlink (UL/DL) allocation, the foregoing configuration may also be used for the format 1A, i.e., the format for the DL allocation (or assignment). Besides, the foregoing configuration may also be applicable to a different DL assignment format including the RA field. Also, even when the format is used for other purposes than the allocation of the UL or DL resource, the RA field may be used for the purpose of SRS.

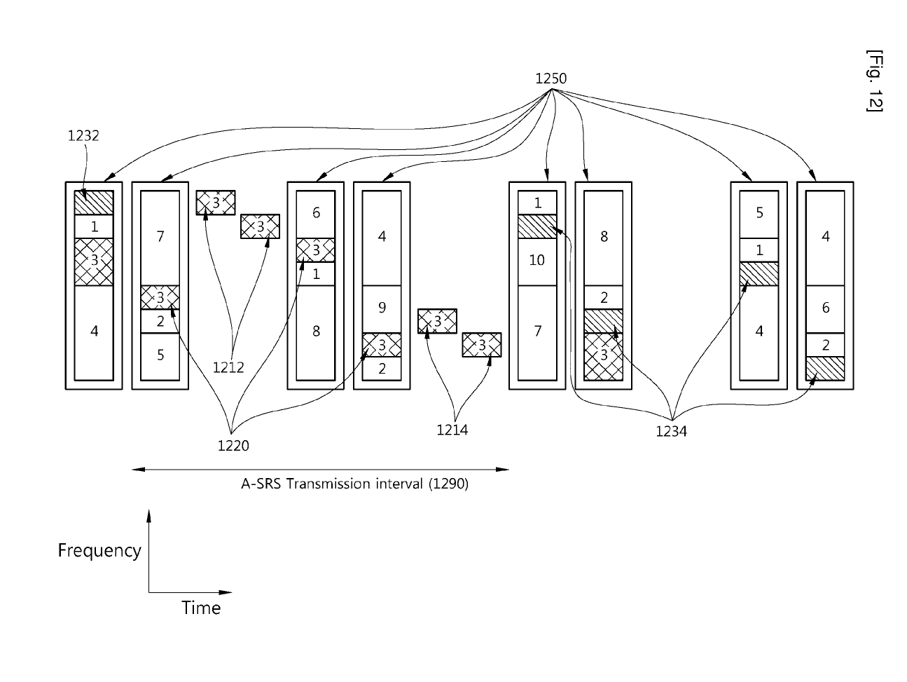

FIG. 11 shows an example of a format of indicating an allocation of SRS resource by using a PDCCH format 0 according to another embodiment of the present disclosure. Specifically, FIG. 11 shows an example of reconfiguring the PDCCH format, which is defined for uplink assignment, as a format exclusive for SRS and using the same. The format illustrated in FIG. 11 includes a mode switch field 1110 indicating an SRS-exclusive format and an aperiodic SRS (A-SRS) number field 1120 indicating the number of transmissions of aperiodic SRS. Also, the format includes an SRS positioning field 1130. As described above, the format may include all of the four types of parameters (the starting point, C_{SRS}, B_{SRS}, and the periodicity) required for allocating the resource of the aperiodic SRS, or may be composed of only the information (the starting point and the periodicity) to be newly provided to the UE, rather than transmitting the information (e.g., C_{SRS} and B_{SRS}) the UE already has in the resource allocation. Also, when the uplink assignment format is used exclusively for SRS, a parameter set which may indicate one or more SRS resources may be transmitted. For example, as shown in FIG. 9, the respective set values of the SRS resources having different periodicities (periodicity #1 and periodicity #2), the respective set values may be configured as one or more sets as indicated by reference numeral 1130 and provided.

{
starting point#1, C_{SRS} (3bit)#1, B_{SRS} (2bit)#1, periodicity#1,
starting point#2, C_{SRS} (3bit)#2, B_{SRS} (2bit)#2, periodicity#2,
...
}

In this case, since resources each having a different starting point, a different bandwidth, and a different periodicity, can be allocated, the flexibility can be increased in transmitting the aperiodic SRS.

FIG. 12 shows an example of an allocation of aperiodic SRS resource according to an embodiment of the present disclosure.

With reference to FIG. 12, a multi-shot SRS is transmitted by utilizing empty resources in the periodic SRS configuration areas and resources in areas other than the periodic SRS configuration areas. Since various resources can be utilized, sounding can be performed on the bandwidth of the overall system within a short time. In detail, reference numeral 1250 indicates periodic SRS-configured frames. In FIG. 12, when the SRS information such as information regarding the starting point, the periodicity and the bandwidth of aperiodic SRS is configured by using the control information channel such as the PDCCH for an aperiodic SRS resource allocation as described above with reference to FIGS. 10 and 11 and transmitted to the UE (e.g., UE 3), the UE 3 transmits aperiodic SRS as indicated by reference numeral 1220 to empty spaces of the periodic SRS configuration areas in the aperiodic transmission intervals denoted by the reference numeral 1290. Also, aperiodic SRS may be transmitted as denoted by reference numerals 1212 and 1214 even in a space, not the periodic SRS configuration area. Reference numerals 1232 and 1234 denote empty resource areas. Since resource of SRS can be allocated by using the control information channel such as the PDCCH, when the configuration information is transmitted before the interval denoted by reference numeral 1290, the following subframe may reflect it and transmit aperiodic SRS.

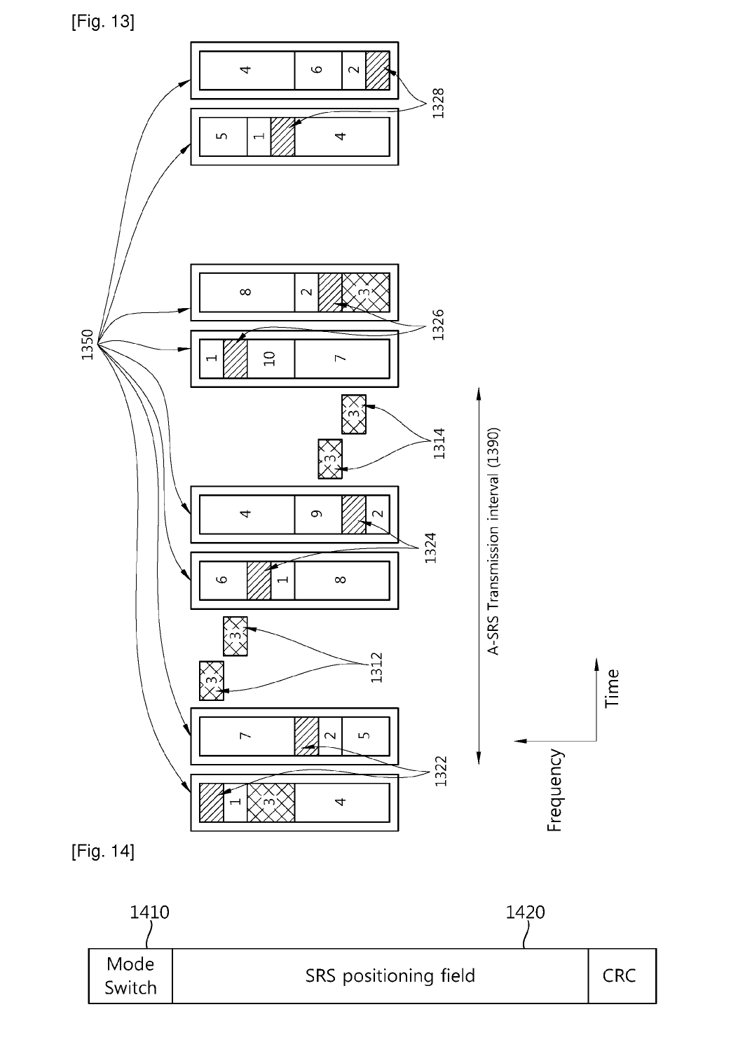

FIG. 13 shows an example of an allocation of aperiodic SRS resource according to another embodiment of the present disclosure. Specifically, FIG. 13 shows a case of using only resource other than the periodic SRS configuration, and in this case, a collision with the existing periodic SRS can be completely avoided.

With reference to FIG. 3, when the SRS information such as information regarding the starting point, the periodicity and the bandwidth of aperiodic SRS is configured by using the control information channel such as the PDCCH for an aperiodic SRS resource allocation as described above with reference to FIGS. 10 and 11 and transmitted to the UE (e.g., UE 3), the UE 3 transmits aperiodic SRS as indicated by reference numerals 1312 and 1314 to empty spaces, not the periodic SRS configuration areas, in the aperiodic transmission intervals denoted by the reference numeral 1390. Namely, it is noted that the UE 3 can transmit the multi-shot SRS as denoted by reference numerals 1312 and 1314 by using the resource of the subframe other than the periodic SRS configuration 1350. Since SRS is not transmitted to the empty spaces 1322, 1324, 1326, and 1328 in the periodic SRS configuration, a collision with the existing periodic SRS can be avoided.

In the embodiment of the present disclosure with reference to FIGS. 12 and 13, the SRS resource is allocated to transmit the multi-shot aperiodic SRS within a short time, and aperiodic SRS is transmitted. The extra portion of control information is used in the LTE or LTE-A system according to an embodiment of the present disclosure, and in this case, when the control information uses the uplink grant format of the PDCCH as shown in FIGS. 10 and 11, it can be used as a value of SRS resource allocation.

FIG. 14 shows an example of a format of indicating an allocation of SRS resource by using a PDCCH format 0 according to still another embodiment of the present disclosure.

Specifically, FIG. 14 shows a format when information regarding a field indicating the number of transmissions of aperiodic SRS is performed according to upper layer signaling, rather than L1 signaling. The value indicating the number of transmissions of the aperiodic SRS is not changed whenever the aperiodic SRS is transmitted, so the value can be separately set according to upper layer signaling. As a result, the format includes a mode switch 1410 and an SRS positioning field 1420 including resource allocation information required for an aperiodic SRS transmission. Types (parameters) of information included in the SRS positioning field may be the starting point of a bandwidth, the size of the bandwidth, the periodicity, and the like, as discussed above, and the BS may transmit only some of the parameters according to circumstances.

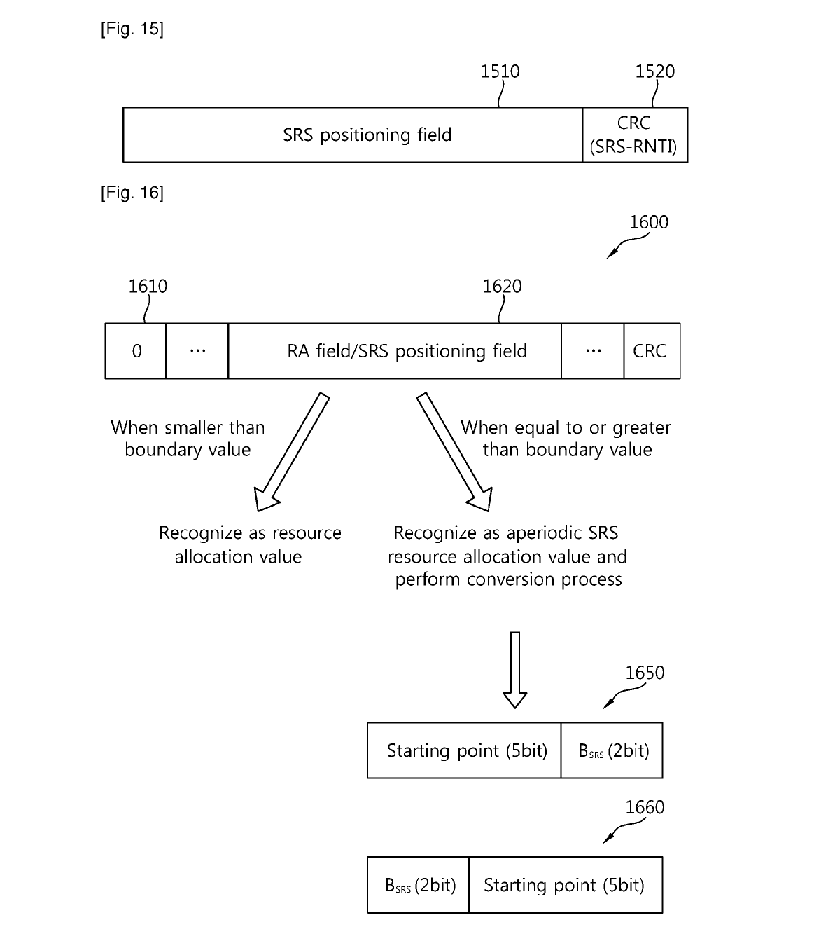

FIG. 15 shows an example of a format of indicating an allocation of SRS resource by using a PDCCH format 0 according to yet another embodiment of the present disclosure. Unlike the case of FIG. 14, the format of FIG. 15 does not include a mode switch. Instead of a mode switch, an SRS-RNTI (Radio Network Temporary Identifier) may be included in a CRC field 1520 in order to indicate that the format is for SRS. In case of the SRS-RNTI in checking the CRC, each user may recognize the corresponding format as an SRS-exclusive format and decode a data value.

Meanwhile, in the LTE or LTE-A system according to an embodiment of the present disclosure, an extra part of control information is used. When the control information uses the format 0, the RA field of the format 0 is used and, in this case, the range of values not used in the RA field may be used as a value of the SRS resource allocation in order to discriminate it from the format 0.

FIG. 16 shows an example of allocation of SRS resource to an RA field area of PDCCH format 0 in each bandwidth according to an embodiment of the present disclosure.

With reference to FIG. 16, the range of value allocated to the RA field in Table 6 is smaller than ‘the range (A) of the indication information’. Thus, when the UE receives the information of the PDCCH format 0 and decodes the RA field value, if the value is greater than ‘the range (A) of the indication information’, the value may be recognized as a value for an aperiodic SRS resource allocation. The range (A) of the indication information may be, for example, a boundary value for determining whether or not it is a value for the RA or a value for the aperiodic SRS resource allocation in each bandwidth.

This can be ascertained through Table 8 shown below.

TABLE 8

| | Resource | Range of | | Range of |
|---|---|---|---|---|
| Bandwidth | Block | Indication | RA | Values for SRS |
| (MHz) | (RG, N_{RB}^{UL}) | Information (A) | value | allocation |
| 20 | 100 | 5050 | 0~5049 | 5050~8191 |
| 15 | 75 | 2850 | 0~2849 | 2850~4095 |
| 10 | 50 | 1275 | 0~1274 | 1275~2047 |
| 5 | 25 | 325 | 0~324 | 325~512 |

With reference to Table 8, when the UE receives data of the PDCCH DCI format 0, it may check such that a value lower than the boundary value is information for a resource allocation and a value greater than the boundary value is information for the aperiodic SRS resource allocation.

The range of the values for an SRS allocation in Table 8 is an example, and all the values are not used for an SRS resource allocation and only some of the values may be used. Also, the values may be used to express different information by using code points.

Meanwhile, as discussed above, information of minimum 7 bits may be used for the SRS resource allocation. FIG. 16 shows a case in which the starting point (5 bits) and BSRS (2 bits) are used as information of the aperiodic SRS resource allocation (1650 and 1660). Reference numeral 1600 denotes the configuration of a PDCCH format 0. Reference numeral 1610 is indication information indicating the PDCCH format 0, and the PDCCH format 0 and a format 1a can be discriminated through this information.

Reference numeral 1620 is an RA field or aperiodic SRS positioning field. When the value of reference numeral 1620 is smaller than the boundary value in Table 8, it is recognized as an RA field and used as PUSCH resource allocation information, and when the value of reference numeral 1620 is greater than the boundary value, the value is recognized as the SRS positioning field and undergoes a certain conversion process to extract 7-bit information of the starting point (5 bits) and B_{SR}s (2 bits) as denoted by reference numerals 1650 and 1660 and use it as aperiodic SRS resource allocation information.

For example, when the value of the reference numeral 1620 area of the PDCCH format 0 information received from the BS in the band width of 20 MHz is ‘3010’, the UE recognizes it as a value for an RA designation, and when the value is ‘5128’ greater than 5050, a conversion process may be performed thereon and ‘78’ obtained by subtracting ‘5050’ from ‘5128’ is indication information for an SRS resource allocation.

‘78’ is ‘1001110’ as a binary number, and when SRS resource is allocated in the form of reference numeral 1650 in FIG. 16, a value ‘10011’ obtained by extracting upper 5 bits is position of the starting point in allocating the aperiodic SRS resource and ‘10’ obtained by extracting lower 2 bits is a value for determining a bandwidth in allocating the aperiodic SRS resource, which corresponds to the case in which B_{SRS} in Table 2 is 2. C_{SRS} may be used to calculate
M_{sc,b}^{RS}

(the length of an SRS sequence) by using Table 2 and Equation 2, and as a result, it can be checked at which position and with which length the aperiodic SRS resource has been allocated.

Of course, as discussed above, in case of 20 MHz and 15 MHz, the information of the extra range of 10 bits or greater can be used, so the information of the starting point (5 bits), B_{SRS} (2 bits), and C_{SRS} (3 bits) may be used by using 10 bits in 20 MHz and 15 MHz.

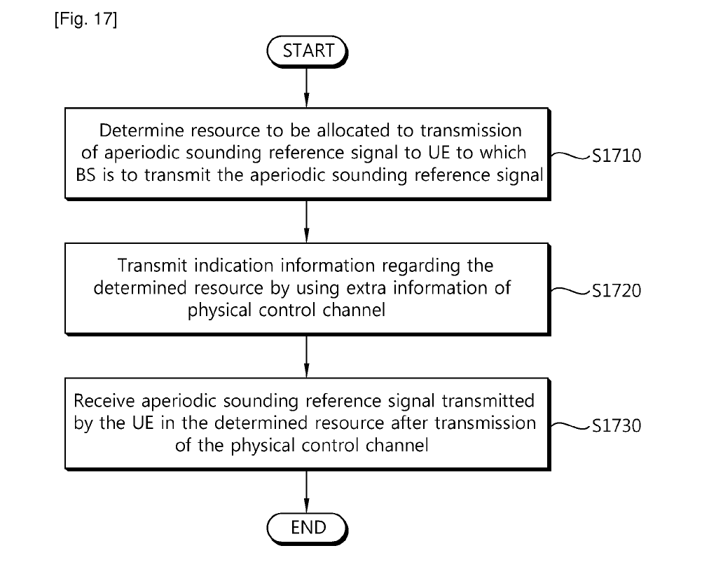

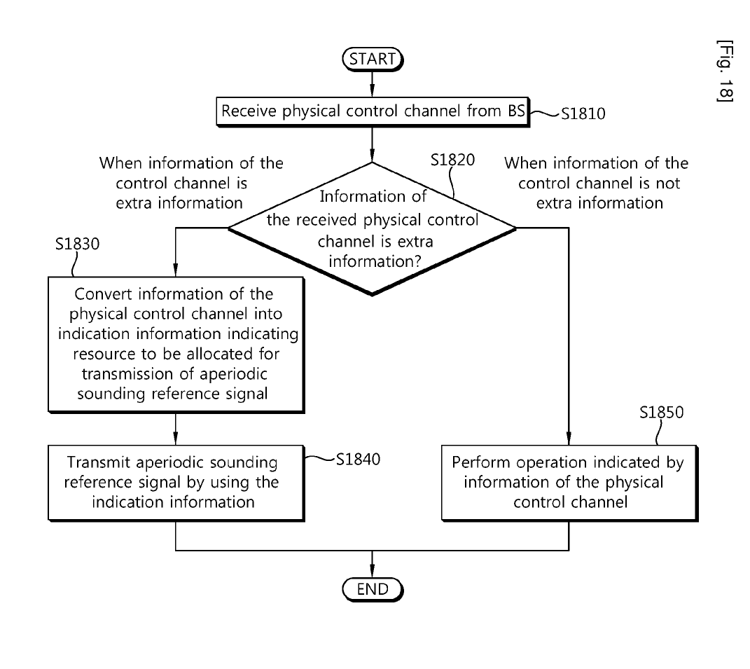

FIG. 17 is a how chart illustrating the process of transmitting, by the BS, resource allocation information for an aperiodic transmission of a sounding reference signal to a UE according to an embodiment of the present disclosure.

With reference to FIG. 17, the BS recognizes that a particular UE is required to transmit aperiodic SRS in a periodic SRS transmission process. Then, the BS determines resource to be allocated for transmitting the aperiodic SRS to the UE to which the aperiodic SRS is to be transmitted (S1710).

The BS transmits indication information regarding the determined resource by using extra information of a physical control channel (S1720). An embodiment of the physical control channel is the PDCCH as mentioned above, and in particular, the indication information is transmitted through the format 0. Also, the extra information may be in a range not used in the RA field for an uplink resource allocation in the format 0 of the PDCCH, and in this case, the extra information may be used to be a value greater than the value for the RA in Table 8. The indication information may be information regarding the start position of the resource and information regarding the bandwidth of the resource. Namely, it may be the information regarding the starting point in the aperiodic SRS resource allocation and the B_{SRS} information required for determining the bandwidth. Of course, it may further include C_{SRS} according to the configuration of a network.

After the transmission of the physical control channel, the BS receives an aperiodic SRS transmitted by the UE in the determined resource (S1730).

FIG. 18 is a how chart illustrating the process of receiving, by the UE, resource allocation information for an aperiodic transmission of the sounding reference signal from the BS according to an embodiment of the present disclosure.

With reference to FIG. 18, the UE periodically receives the physical control channel from the BS (SI 810). The physical control channel may be, for example, a PDCCH.

The UE decodes the received physical channel to check whether the information of the physical control channel is extra information (SI 820). For example, when the physical channel is a PDCCH and the format is format 0, the extra information may be checked whether or not it is in a range not used in the field for the uplink resource allocation.

In the above, the range of the values for the uplink resource allocation and the otherwise range are discriminated, and when information is not within the range of the values for the uplink resource allocation, the information is determined to be extra information.

In case of the extra information, the UE determines it as information for allocating aperiodic SRS resource and converted into indication information indicating resource, and converts the information of the physical control channel into indication information indicating resource be allocated for a transmission of the aperiodic SRS (S1830).

In an embodiment of the conversion, the UE may subtract a boundary value in Table 8 from the extra information and divides the obtained value by each of the components (the starting point and the BSRs information) of the indication information for allocating the aperiodic SRS resource as denoted by 1650 or 1660 in FIG. 16 to obtain information regarding a starting point of the resource and information regarding the bandwidth of the resource.

Thereafter, the UE transmits the aperiodic SRS by using the indication information (SI 840).

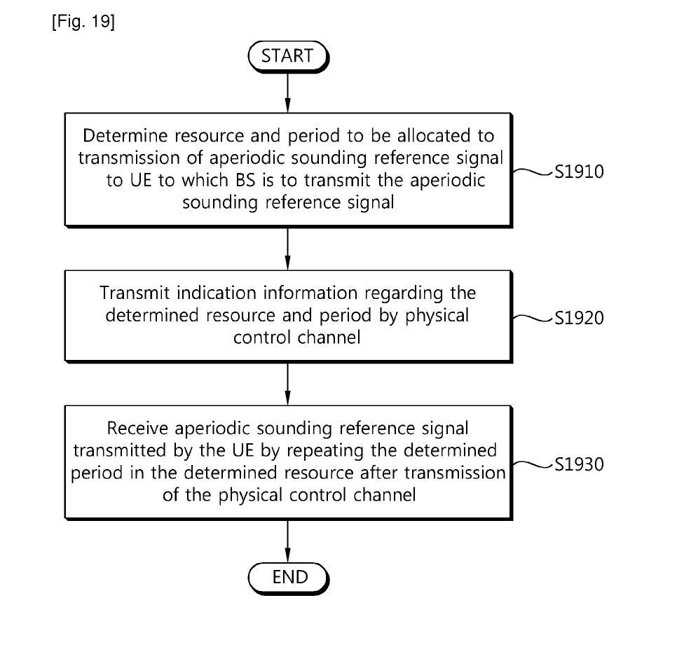

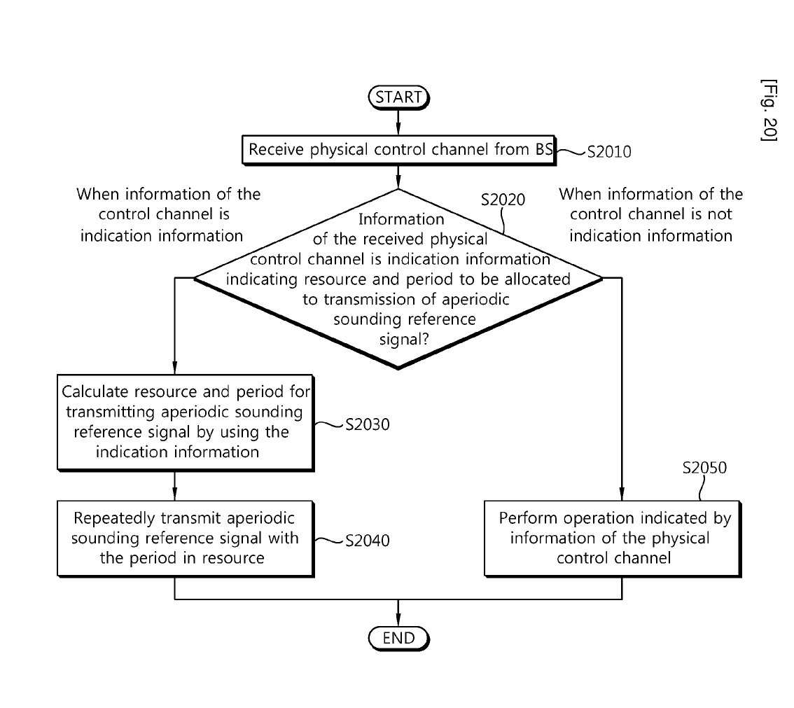

FIG. 19 is a how chart illustrating the process of transmitting, by a base station (BS), resource allocation and period information for an aperiodic transmission of a sounding reference signal to a user equipment (UE) according to an embodiment of the present disclosure.

With reference to FIG. 19, the process of providing information regarding resource and a period to the UE to allow for an aperiodic SRS transmission so as to periodically perform sounding during a certain period of time is shown.

The BS recognizes that a particular UE is required to transmit aperiodic SRS in a periodic SRS transmission process. Then, the BS determines resource and period to be allocated for transmitting the aperiodic SRS to the UE to which the aperiodic SRS is to be transmitted (S1910). Here, like the bandwidth and the starting point discussed above, the resource and period include radio resource for transmitting the aperiodic SRS and information regarding at which intervals, i.e., at which periods, the aperiodic SRS is to be transmitted. The radio resource is resource of the starting point and the aperiodic SRS may be transmitted through hopping according to the periods, and such a hopping pattern can be also received by the UE according to upper layer signaling. The BS transmits indication information regarding the determined resource and period by using extra information of a physical control channel (S1920). The indication information includes one or more of information regarding the start position of the resource, the information regarding the bandwidth of the resource, and the information regarding the interval for transmitting the aperiodic SRS.

The physical control channel may be, for example, the PDCCH as mentioned above, and in particular, the physical control channel is transmitted through the format 0 in relation to the uplink allocation. As the format related to the transmission, the formats illustrated in FIGS. 10, 11, 14, and 15 may be used. In case of FIG. 10, the physical control channel is a PDCCH, and the indication information may express resource and period information (or periodicity) to be allocated for an SRS transmission by using a value within the range not in used in the field for an uplink resource allocation in the format 0 of the PDCCH and filler bits. Also, in case of FIGS. 11, 14, and 15, larger aperiodic SRS allocation information may be configured, and in this case, information indicating resource and period to be allocated for a transmission of the aperiodic SRS with respect to two or more UEs may be included in the indication information.

Thereafter, the BS receives an aperiodic SRS from the resource-allocated UE. Namely, after the transmission of the physical control channel, the BS receives the aperiodic SRS transmitted repeatedly at the determined periods by the UE in the determined resource (S1930). The resource transmitted in step S1910 is related to a first aperiodic SRS transmission of the period, and a transmission of the aperiodic SRS to be transmitted next may vary according to a hopping pattern.

FIG. 20 is a how chart illustrating the process of receiving, by the UE, resource allocation and period information for an aperiodic transmission of the sounding reference signal from the BS according to an embodiment of the present disclosure.

With reference to FIG. 20, the process of receiving, by the UE, information regarding the resource and period allowing for performing sounding periodically during a certain period of time, and transmitting an SRS is shown.

The UE receives the physical control channel from the BS (S2010). The UE decodes the received physical channel to check whether or not information of the received physical control channel is indication information indicating the resource and period to be allocated for a transmission of the aperiodic SRS (S2020). The physical control channel may be, for example, a PDCCH. The physical control channel is a PDCCH and, in particular, it may be received through the format 0 in relation to the uplink allocation. As the format related to the SRS transmission, the formats illustrated in FIGS. 10, 11, 14, and 15 may be used. In case of FIG. 10, the physical control channel is a PDCCH, and the indication information may express resource and period information (or periodicity) to be allocated for an SRS transmission by using a value within the range not in used in the field for an uplink resource allocation in the format 0 of the PDCCH and filler bits. In this case, whether or not it is included in the value of the extra range may be checked. Also, in case of FIGS. 11, 14, and 15, larger aperiodic SRS allocation information may be configured, and in this case, information indicating resource and period to be allocated for a transmission of the aperiodic SRS with respect to two or more UEs may be included in the indication information. It may be checked whether or not the corresponding PDCCH is indication information indicating resource and a period to be allocated for the transmission of the aperiodic SRS by using a mode switch, an SRS-RNTI, or the like.

When the information of the control channel is indication information, resource and a period for transmitting the aperiodic SRS are calculated by using the indication information (S2030). The indication information may include one or more of information regarding the start position of the resource, information regarding the bandwidth of the resource, and information regarding an interval for transmitting the aperiodic SRS. In case of FIG. 10 as described above, only the starting point and the period information (or periodicity) are received, and as the information regarding the bandwidth, the previously received information or the information received by using the upper layer signaling may be used. Also, in case of using the formats of FIGS. 11, 14, and 15, the indication information may include information indicating the resource and period to be allocated for the transmission of the aperiodic SRS with respect to two or more UEs. When information regarding radio resource at a starting point is calculated by using such types of information, the aperiodic SRS may be calculated to be transmitted with the intervals according to the periodicity by using the previously received hopping pattern later. Thereafter, the aperiodic SRS is repeatedly transmitted with the periods (S2040).

Of course, when the information of the control channel is not related to the aperiodic SRS, an operation indicated by the corresponding physical control channel may be performed (S2050).

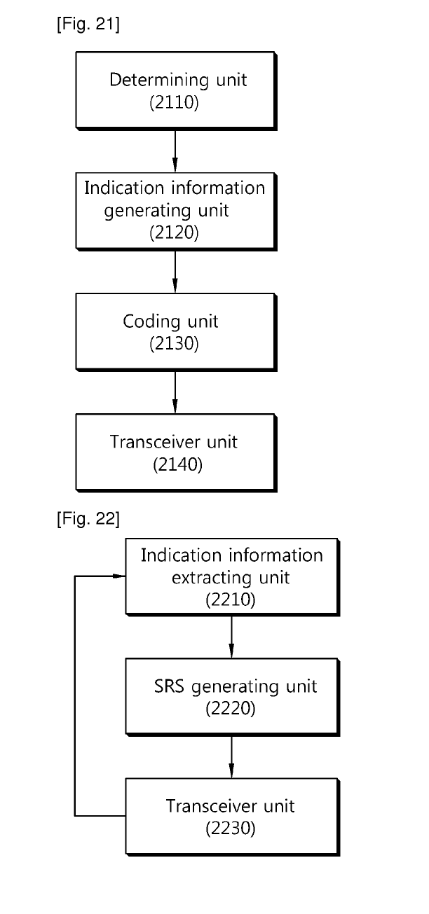

FIG. 21 is a schematic block diagram of a device for transmitting resource allocation information for an aperiodic transmission of a sounding reference signal according to an embodiment of the present disclosure. The configuration of FIG. 21 may be a BS or a device coupled with the BS.

With reference to FIG. 21, the overall configuration includes a determining unit 2110, an indication information generating unit 2120, a coding unit 2130, and a transceiver unit 2140. Of course, the configuration may further include a different element to provide such a function as that of a BS.

The BS recognizes that a particular UE is required to aperiodically transmit an SRS in a periodic SRS transmission process. The determining unit 2110 determines resource and period to be allocated for a transmission of the aperiodic SRS to the UE to which the aperiodic SRS is to be transmitted by the BS. Here, like the bandwidth and the starting point discussed above, the resource and period include radio resource for transmitting the aperiodic SRS and information regarding at which intervals, i.e., at which periods, the aperiodic SRS is to be transmitted. The radio resource is resource of the starting point and the aperiodic SRS may be transmitted through hopping according to the periods, and such a hopping pattern can be also received by the UE according to upper layer signaling.

The determining unit 2110 also determines whether to include an ASRS activation field in the DCI format 0. In addition, the determining unit 2110 may determine that the flat of the DCI format 0 indicates a transmission mode (or configuration mode) of an ASRS configuration parameter. In this case, the flag may be called a mode switch, which will be described later.

The indication information generating unit 2120 generates indication information indicating indication information regarding the determined resource and period. The indication information includes one or more of information regarding the start position of the resource, the information regarding the bandwidth of the resource, and the information regarding the interval for transmitting the aperiodic SRS.

Also, the indication information generating unit 2120 may generate an uplink grant including the ASRS configuration parameter. The uplink grant may mean the DCI format 0.

The coding unit 2130 generates a radio signal by including the indication information in a physical control channel. The physical control channel may be, for example, the PDCCH as mentioned above, and in particular, the physical control channel is transmitted through the format 0 in relation to the uplink allocation. As the format related to the transmission, the formats illustrated in FIGS. 10, 11, 14, and 15 may be used. In case of FIG. 10, the physical control channel is a PDCCH, and the indication information may express resource and period information (or periodicity) to be allocated for an SRS transmission by using a value within the range not in used in the field for an uplink resource allocation in the format 0 of the PDCCH and filler bits. Also, in case of FIGS. 11, 14, and 15, larger aperiodic SRS allocation information may be configured, and in this case, information indicating resource and period to be allocated for a transmission of the aperiodic SRS with respect to two or more UEs may be included in the indication information.

The transceiver unit 2140 transmits the radio signal to the UE, and receives an aperiodic SRS repeatedly at the determined periods in the determined resource from the resource-allocated UE. Namely, after the transmission of the physical control channel, the BS receives the aperiodic SRS transmitted repeatedly at the determined periods by the UE in the determined resource. The resource indicated by the indication information generating unit 2120 is related to a first aperiodic SRS transmission of the period, and a transmission of the aperiodic SRS to be transmitted next may vary according to a hopping pattern.

FIG. 22 is a schematic block diagram of a device for receiving resource allocation and period information for an aperiodic transmission of a sounding reference signal according to an embodiment of the present disclosure.

With reference to FIG. 22, the device may be a receiving device, namely, a terminal, and includes an indication information extracting unit 2210, an SRS generating unit 2220, and a transceiver unit 2230.

In detail, the transceiver unit 2230 receives a radio signal including a physical control channel from a BS, and transmits a sounding reference signal (SRS).

The indication information extracting unit 2210 checks whether or not information of the received physical control channel is extra information. When the information of the control channel is extra information, the indication information extracting unit 2210 converts the information of the physical control channel into indication information indicating resource to be allocated for a transmission of an aperiodic SRS. The physical control channel may be, for example, a PDCCH, and the extra information may be within a range not used for the field for an uplink resource allocation in the format 0 of the PDCCH.

As discussed above with reference to Table 8, the information of the PDCCH, which is not a value for the uplink resource allocation and transmitted through the format 0, may be recognized as information indicating an allocation of resource required for transmitting the aperiodic SRS.

The indication information extracting unit 2210 extracts indication information including information regarding a start position of the resource and information regarding the bandwidth of the resource. The SRS generating unit 2220 generates an aperiodic SRS by using the indication information. The thusly generated aperiodic SRS is transmitted through the transceiver unit 2230.

In this document, in transmitting the aperiodic SRS, immediate information such as the physical control channel is provided to the UE, to allow the UE to transmit the SRS at an appropriate time. Also, the bandwidth and position of the required SRS can be signaled while minimizing overhead of the PDCCH.

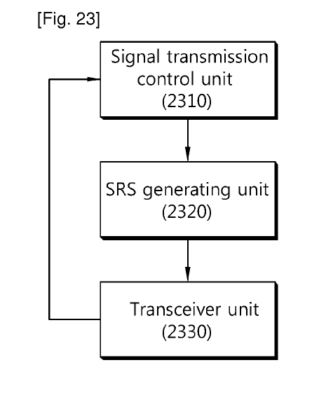

FIG. 23 is a schematic block diagram of a device for receiving resource allocation and period information for an aperiodic transmission of a sounding reference signal according to another embodiment of the present disclosure.

With reference to FIG. 23, the device may be a receiving device, i.e., a UE. The device includes a signal transmission controller 2310, an SRS generating unit 2320, and a transceiver unit 2330. Through the configuration illustrated in FIG. 23, the UE is provided with information regarding resource and a period allowing for the UE to perform sounding periodically during a certain period of time, and transmits an SRS.

In detail, the transceiver unit 2330 receives a radio signal including a physical control channel from a BS and transmits an SRS. Also, the transceiver unit 2330 receives an uplink grant from the BS and performs CRC checking thereon. The uplink grant includes any one of type 1 and type 2. The uplink grant of type 2 includes a 1-bit ASRS activation field and a 1-bit mode switch.

The signal transmission controller 2310 checks whether or not the uplink grant is type 1 or type 2. Also, the signal transmission controller 2310 recognizes a transmission mode (or a configuration mode) of the ASRS configuration parameter based on the mode switch. The signal transmission controller 2310 determines whether to interpret the uplink grant according to the conventional method or according to a new method for a transmission of the ASRS configuration parameter based on the ASRS activation field and the mode switch.

The signal transmission controller 2310 decodes the received physical channel to check whether or not information of the received physical control channel is indication information indicating resource and a period to be allocated for the transmission of the aperiodic SRS. When the information of the control channel is the indication information, the signal transmission controller 2310 may calculate resource and a period for transmitting the aperiodic SRS by using the indication information. The physical control channel may be, for example, a PDCCH. The physical control channel is a PDCCH and, in particular, the physical control channel can be received through the format 0 in relation to the uplink allocation. As the format related to the transmission of SRS, the formats illustrated in FIGS. 10, 11, 14, and 15 may be used. In case of FIG. 10, the physical control channel is a PDCCH, and the indication information may express resource and period information (or periodicity) to be allocated for an SRS transmission by using a value within the range not in used in the field for an uplink resource allocation in the format 0 of the PDCCH and filler bits. In this case, whether it is included in the value of the extra range can be checked. Also, in case of FIGS. 11, 14, and 15, larger aperiodic SRS allocation information may be configured, and in this case, information indicating resource and period to be allocated for a transmission of the aperiodic SRS with respect to two or more UEs may be included in the indication information. It may be checked whether or not the corresponding PDCCH is indication information indicating resource and a period to be allocated for the transmission of the aperiodic SRS by using a mode switch, an SRS-RNTI, or the like. The indication information may include one or more of information regarding the start position of the resource, information regarding the bandwidth of the resource, and information regarding an interval for transmitting the aperiodic SRS. In case of FIG. 10 as described above, only the starting point and the period information (or periodicity) are received, and as the information regarding the bandwidth, the previously received information or the information received by using the upper layer signaling may be used. Also, in case of using the formats of FIGS. 11, 14, and 15, the indication information may include information indicating the resource and period to be allocated for the transmission of the aperiodic SRS with respect to two or more UEs. When information regarding radio resource at a starting point is calculated by using such types of information, the aperiodic SRS may be calculated to be transmitted with the intervals according to the periodicity by using the previously received hopping pattern later.

Table 9 below shows allocation of 3 bits in order to indicate information related to periodicity as described above. Periodicity may be allocated as 3-bit information with respect to 2 ms, 5 ms, 10 ms, 20 ms, 40 ms, 80 ms, 160 ms, and 320 ms. Of course, which value is to be allocated may vary according to an implementation. According to Table 9, when information ‘001’ related to periodicity is received, an aperiodic SRS may be transmitted by the period of 5 ms.

TABLE 9

| | SRS Periodicity |
|---|---|
| Periodicity | T_{SRS} (ms) |
| 000 | 2 |
| 001 | 5 |
| 010 | 10 |
| 011 | 20 |
| 100 | 40 |
| 101 | 80 |
| 110 | 160 |
| 111 | 320 |

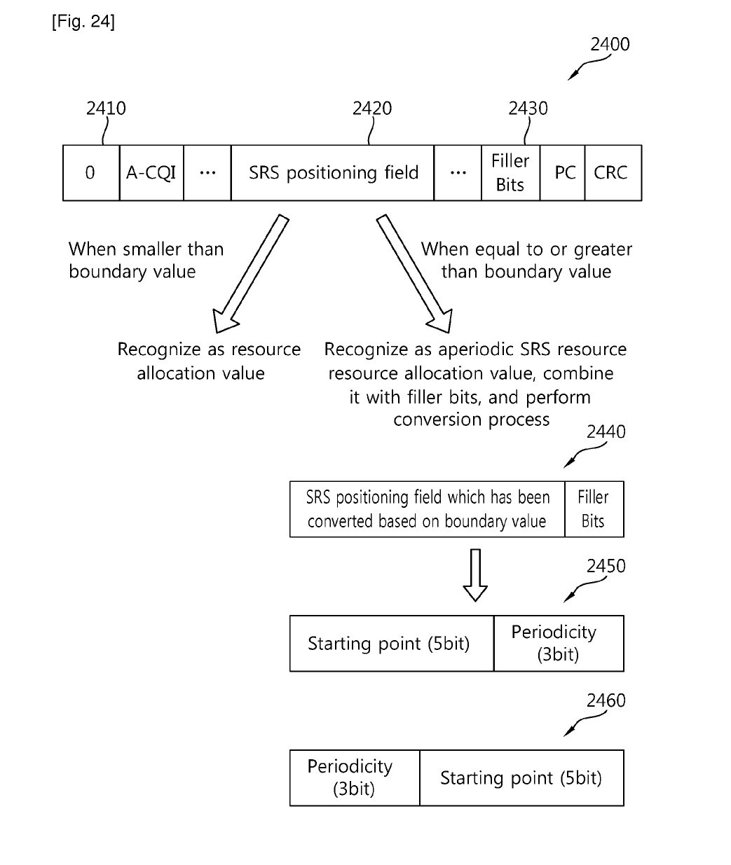

FIG. 24 shows indication information indicating an allocation of resource for a periodic transmission of an aperiodic SRS by using a PDCCH format 0 according to an embodiment of the present disclosure. Specifically, FIG. 24 shows an example of using the format 0 of the PDCCH as shown in FIG. 10 and configuring it by using filter bits. In the above description, the information of the extra range of the RA field is used in the PDCCH format 0. The range of the value for an aperiodic SRS allocation has been described above with reference to Table 8.

The range of value allocated to the RA field in Table 6 is smaller than ‘the range (A) of the indication information’. Thus, when the UE receives the information of the PDCCH format 0 and decodes the RA field value, if the value is greater than ‘the range (A) of the indication information’, the value may be recognized as a value for an aperiodic SRS resource allocation. The range (A) of the indication information may be, for example, a boundary value for determining whether or not it is a value for the RA or a value for the aperiodic SRS resource allocation in each bandwidth. This can be ascertained through Table 8.

In case of applying Table 8, when the UE receives data of the PDCCH DCI format 0, it may check such that a value lower than the boundary value is information for a resource allocation and a value greater than the boundary value is information for the aperiodic SRS resource allocation. The range of the values for an SRS allocation in Table 8 is an example, and all the values are not used for an SRS resource allocation and only some of the values may be used. Also, the values may be used to express different information by using code points. Meanwhile, in FIG. 10, filler bits are used, and a resource allocation and period in the periodical transmission of the aperiodic SRS may be indicated with a total of 8 bits by providing only information regarding the starting point.

As discussed above, information of minimum 8 bits may be used for the allocation of resource and period for a periodic transmission of the aperiodic SRS. FIG. 24 shows a case in which the starting point (5 bits) and the periodicity (3 bits) as in the embodiment of Table 9 are used as information of the aperiodic SRS resource allocation (2450 and 2460). Reference numeral 2400 denotes the configuration of a PDCCH format 0. Reference numeral 2410 is indication information indicating the PDCCH format 0, and the PDCCH format 0 and a format 1a can be discriminated through this information. Reference numeral 2420 is an RA field or aperiodic SRS positioning field. When the value of reference numeral 2420 is smaller than the boundary value in Table 8, it is recognized as an RA field and used as PUSCH resource allocation information, and when the value of reference numeral 2420 is greater than the boundary value, the value is recognized as the SRS positioning field and is combined with filler bits through a certain conversion process to extract 8-bit indication information, i.e., the starting point (5 bits) and the periodicity (3 bits) information as denoted by reference numerals 2450 and 2460 and use it as aperiodic SRS resource allocation information and period information. For example, when the value of the reference numeral 2420 area of the PDCCH format 0 information received from the BS in the band width of 20 MHz is ‘3010’, the UE recognizes it as a value for an RA designation, and when the value is ‘5128’ greater than ‘5050’, a conversion process may be performed thereon and ‘78’ obtained by subtracting ‘5050’ from ‘5128’ is indication information for an SRS resource allocation. Meanwhile, it is assumed that the filler bits 2430 is ‘1’. Meanwhile, ‘78’, the result of the subtraction of ‘5050’, is ‘1001110’ as a binary number, and when it is combined with the filler bits, ‘10011101’ is obtained.

When the SRS resource and period are allocated in the form of reference numeral 2450, a value ‘10011’ obtained by extracting upper 5 bits is a position of the starting point in allocating the aperiodic SRS, and ‘101’ obtained by extracting lower 3 bits is a value for determining a bandwidth in allocating the aperiodic SRS resource. Thus, the period is 80 ms in case of Table 9. Meanwhile, as the information (B_{SRS} and C_{SRS}) required for allocating the aperiodic SRS resource, the information which has been previously used by the corresponding UE may be used as it is, so
M_{sc,b}^{RS}

(the length of an SRS sequence) may be calculated by using Table 2 and Equation 2, and as a result, it can be checked at which position and with which length the aperiodic SRS resource has been allocated. Thereafter, in order to periodically transmit the aperiodic SRS, the UE may transmit an SRS one time by using the previously received starting point information and the bandwidth information (B_{SRS} and C_{SRS}), and then, transmit an SRS having the same length at a starting point of a new bandwidth calculated according to a hopping pattern with an interval (80 ms) indicated in the periodicity information.

In FIG. 24, the length of the PDCCH format 0/1 A is used as it is as the format for indicating the resource and period of the aperiodic SRS. In case of a bandwidth of 24 MHz, is 100 RBs and 13 bits are allocated to reference numeral 2420 which is an RA field and SRS positioning field. The 13-bit area is used for allocating a resource block to the UE, and the actually allocated values ranges from ‘0’ to ‘5049’. Meanwhile, information which can be expressed by 13 bits ranges from ‘0’ to ‘8191’. Namely, since values not used in the RA field ranges from ‘5050’ to ‘8191’, the unused values may be used for a resource allocation of the SRS. Namely, FIG. 24 shows an example of indicating positioning information (SRS positioning) for allocating SRS resource by using the existing PDCCH format 0 used for the uplink grant, without increasing PDCCH overhead or without increasing a blind decoding level. Since the existing RA field of the PDCCH is used, complexity in PDCCH decoding cannot be increased.

In order to use the RA field as an SRS positioning field, the range of values not used in the RA field may be used. As mentioned above, ‘5050’ to ‘8191’ are the range of unused values, and this range can express about 11-bit information. Thus, when the size of the value included in the RA field is smaller than ‘5050’, the UE may confirm that the value will be used as the RA field, and when the value is ‘5050’ or greater, the UE may map the value to a certain value of 11 bits to use it as information of an SRS resource allocation.

Namely, in the scheme of designating an SRS BW, since it is greater than the unit of resources to be actually allocated to the user, the BW of the SRS resources can be expressed with bits smaller than the bit information of the existing RA, BW for the SRS can be designated by using the remaining code points in the current format 0. Thus, for a user for which resources are allocated for every subframe, without using SPS (Semi Persistent Scheduling), when the DCI format 0 designating SRS BW for an aperiodic SRS comes down in order to prevent an unnecessary increase in the PDCCH, the DCI format 0 may be recognized as a resource allocation for an SRS, rather than a resource allocation for an actual data transmission, and resource which has been allocated in a previous subframe may be used as it is as resource for data. For example, the RA field coming down with the DCI format 0 in the 20 MHz (100 RBs) has 13-bit information. However, as mentioned above, only values smaller than 5050 used for the RA allocation, so when a remaining value ranging from 5050 to 8191 (about 11 bits), exceeding the actual RA field value (0 to 5049) is designated, it may be determined as an SRS resource allocation. Since a minimum unit of BW used for the SRS transmission is 4 RBs, BW required for the SRS transmission can be sufficiently designated in the 100-RB band only with the 9-bit information.

Here, when 11 bits are used as indication information for allocating SRS resource, it can express all of the starting point (5 bits), C_{SRS} (3 bits), and B_{SRS} (2 bits), the parameters required for allocating the SRS resource. Meanwhile, in the bandwidth smaller than 20 MHz, the length of the PDCCH format 0 may be reduced, and in this case, filler bits 1830 may be used. Namely, when information which can be provided at a minimum level is 8 bits, the filler bits may be used or may not be used according to a network bandwidth. As described above with reference to Table 6, the size of the RA field, i.e., the SRS positioning field, is 8 bits or greater in 10 MHz, 15 MHz, and 20 MHz, the filler bits are not used, while the filler bits may be used only in 5 MHz to configure 8 bits according to an embodiment of the present invention.

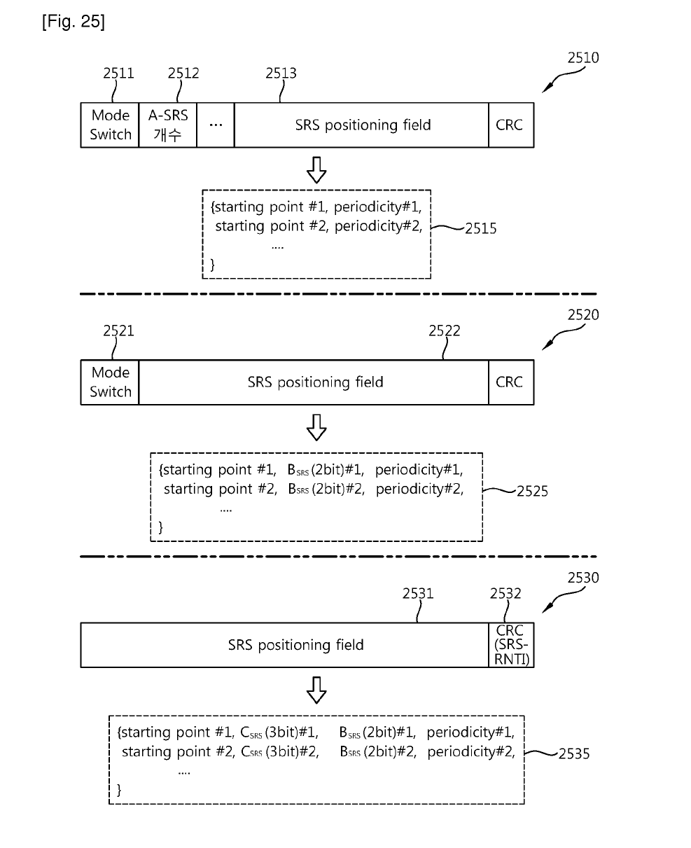

FIG. 25 shows indication information indicating an allocation of resource for a periodic transmission of an aperiodic SRS by using a PDCCH format 0 according to another embodiment of the present disclosure.

With reference to FIG. 25, unlike the case of FIG. 24, indication information which may be included in case of an exclusive format in relation to an SRS resource allocation is presented by using mode switch 2511 and 2521 or a CRC (SRS-RNTI, 2532).

Reference numeral 2510 is an embodiment of FIG. 11, showing a case in which resource allocation and periodicity information for a transmission of the aperiodic SRS are provided to a plurality of UEs. The number of UEs may be indicated in an ASRS number field 2512, and information regarding a starting point and periodicity may be set for each UE like 2515 with the information of the field 2513. Since only the information regarding the starting point and the periodicity is provided, each UE uses the range (B_{SRS} and C_{SRS}) of the bandwidth defined originally to transmit the SRS.

Reference numeral 2520 is an embodiment of FIG. 14, showing a case in which a resource allocation and periodicity information for a transmission of the aperiodic SRS are provided to a plurality of UEs. 2520 is an SRS resource allocation-exclusive format as it is checked through a mode switch 2521. A starting point, B_{SRS}, and periodicity information as denoted by reference numeral 2525 may be provided as information included in the field denoted by reference numeral 2522. When C_{SRS}, cell-specific information, is not provided separately, it is calculated as an already recognized value C_{SRS} to calculate a bandwidth.

Reference numeral 2530 is an embodiment of FIG. 15, shown a case in which a resource allocation and periodicity information for a transmission of the aperiodic SRS are provided to a plurality of UEs. Reference numeral 2530 is an SRS resource allocation-exclusive format as it is checked by using CRC information 2532. A starting point, C_{SRS}, B_{SRS}, and periodicity information as denoted by reference numeral 2535 may be provided as information included in the field denoted by reference numeral 2531. Since bandwidth can be freely set by each UE, an aperiodic SRS transmission, independent from the information (C_{SRS} and B_{SRS}) used for a previous periodic SRS transmission, can be possibly performed.

The example in which various types of information 2515, 2525, and 2535 are included the formats 2510, 2520, and 2530, respectively, has been described. The formats and the types of information may be variably matched to be used. Namely, information denoted by reference numeral 2515 may be stored in the format denoted by reference numeral 2530, and in this case, the number of UEs which can be designated may increase. Also, for periodicity, 3-bit periodicity information, excluding offset information, is provided, but certain offset information may be given to the UE and the periodicity information may also be provided together. In providing information required for the aperiodic SRS transmission, many bits can be used together with 2531, and when a bandwidth is large, information is provided through the PDCCH one time with respect to the entire UEs and information regarding a temporal period, i.e., an offset, to be started to transmit the aperiodic SRS by each UE may be provided separately as shown below. Of course, the offset information may be configured to be different from Table 7 according to an implementation scheme.

{
starting point#1,periodicity#1, off set#1
starting point#2,periodicity#2, offset#2
...
}

An example of the DCI format 0 is shown in Table 10 below.

TABLE 10
Flag for format0/formatl1A differentiation - 1 bit, where value 0
indicates format 0 and value 1 indicates format 1A
Hopping flag - 1 bit
Resource block assignment and hopping resource allocation -
┌log₂ (N_{RB}^{UL} (N_{RB}^{UL} + 1)/2)┐ bits
For PUSCH hopping:
N_{UL}_{_{—}}ₕₒₚ MSB bits are used to obtain the value of ñ_{PRR} (i)
(┌log₂ (N_{RB}^{UL} (N_{RB}^{UL} + 1)/2)┐ − N_{UL}_{_{—}}ₕₒₚ) bits provide the resource
allocation
of the first slot in the UL subframe
For non-hopping PUSCH
(┌log₂ (N_{RB}^{UL} (N_{RB}^{UL} + 1)/2)┐) bits provide the resource allocation
in the UL subframe
Modulation and coding scheme and redundancy version - 5 bits
New data indicator - 1 bit
TPC command for scheduled PUSCH - 2 bits
Cyclic shift for DM RS 3 bits
UL index - 2 bits (this field is present only for TDD operation
with uplink-downlink configuration 0)
Downlink Assignment Index (DAI) - 2 bits (this field is present
only for TDD operation with uplink-downlink configurations 1-6)
CQI request- 1 bit

With reference to FIG. 10, the flag is 1-bit information, which is an indicator for discriminating DCI 0 and DCI 1A. A hopping flag is 1-bit information and indicates whether or not frequency hopping is applied when a UE performs an uplink transmission. For example, when the hopping flag is 1, frequency hopping is applied in performing an uplink transmission, and when the hopping flag is 0, frequency hopping is not applied in performing an uplink transmission.

The DCI format 0 is divided into type 1 and type 2. When Table 10 is the type 1, the type 2 additionally includes an 1-bit ASRS activation field. For example, when the DCI format 0 of Table 10 is 40 bits, the DCI format 0 of the type 2 is 41 bits. Whether or not the DCI format 0 is type 1 or type 2 may be set by an RRC layer. The ASRS activation field is an additional field for indicating an activation of the aperiodic SRS. The ASRS activation field is included in the SRS positioning fields 2513, 2522, and 2531 in FIG. 25.

When the ASRS activation field is 0, it indicates that the aperiodic SRS is deactivated. In this case, the DCI format 0 of type 2 is as shown in Table 11 below.

TABLE 11
Flag for format0/formatl1A differentiation - 1 bit, where value 0
indicates format 0 and value 1 indicates format 1A
Hopping flag - 1 bit
Resource block assignment and hopping resource allocation -
┌log₂ (N_{RB}^{UL} (N_{RB}^{UL} + 1)/2)┐ bits
For PUSCH hopping:
N_{UL}_{_{—}}ₕₒₚ MSB bits are used to obtain the value of ñ_{PRR} (i)
(┌log₂ (N_{RB}^{UL} (N_{RB}^{UL} + 1)/2)┐ − N_{UL}_{_{—}}ₕₒₚ) bits provide the resource
allocation of the first slot in the UL subframe
For non-hopping PUSCH
(┌log₂ (N_{RB}^{UL} (N_{RB}^{UL} + 1)/2)┐) bits provide the resource allocation
in the UL subframe
Modulation and coding scheme and redundancy version - 5 bits
New data indicator - 1 bit
TPC command for scheduled PUSCH - 2 bits
Cyclic shift for DM RS 3 bits
UL index - 2 bits (this field is present only for TDD operation
with uplink-downlink configuration 0)
Downlink Assignment Index (DAI) - 2 bits (this field is present
only for TDD operation with uplink-downlink configurations 1-6)
CQI request- 1 bit
ASRS activation-1 bit

Meanwhile, when the ASRS activation field is 1, it indicates that the aperiodic SRS is activated. When the aperiodic SRS is activated, the UE transmits the aperiodic SRS or enters a state in which it can transmit the aperiodic SRS. In this case, the problem is a method for obtaining, by the UE, ASRS configuration parameters required for transmitting the aperiodic SRS.

The ASRS configuration parameter may include various fields required for the transmission of the ASRS as shown in Table 12 below.

TABLE 12

| SRS Information | Number | |
|---|---|---|
| Element | of Bits | Comment |
| Transmission BW | 2 | Four SRS BWs per operating BW |
| Frequency Position | 3 or 5 | Starting BW Position |
| | | (3 bits for <=5 MHz) |
| Transmission Comb | 1 | Two combs |
| SRS Cyclic Shift | 3 | Eight cyclic shifts |
| SRS Configuration | 9 | configurations on subframes |
| Index I_{SRS} | | assigned for SRS transmission |
| Duration | 0 | One-Shot Transmission or Same |
| | | Duration |
| SRS BW Configuration | 0 | One-shot or already known |
| | | through SIB |
| CRC (UE ID) | 16 | UE ID masked in the CRC |
| TOTAL | 35 or 37 | |

With reference to Table 12, a transmission bandwidth (BW) indicates the number of SRS transmission bandwidths per operating bandwidth. A frequency position field is a parameter for determining a starting point of an uplink bandwidth regarding an ASRS. A transmission comb field is a parameter defining a UpPTS interval belonging to a special subframe in a TDD system. An SRS configuration index field is a parameter for determining the position, offset, and the like, of a subframe in which ASRS is transmitted. A cyclic shift field is a parameter for generating a sequence for transmitting the ASRS.

In order to obtain the ASRS configuration parameter, it must be assumed that the ASRS activation field basically indicates an activation of the periodic SRS. In this case, the UE may previously receive the ASRS configuration parameter from system information or an RRC layer without the assumption of the activation of the aperiodic SRS according to circumstances. The method for obtaining, by the UE, the ASRS configuration parameter will now be described.

In an embodiment, the BS may provide the ASRS configuration parameter as an RRC message to the UE. This is called an ASRS configuration mode 1 (i.e., mode switch=‘0’).

In a different embodiment, the BS may provide the ASRS configuration parameter to the UE through a PDCCH. This is called an ASRS configuration mode 2 (i.e., mode switch=‘1’).

The ASRS configuration mode is identified by the mode switches 2511 and 2521. The mode switches 2511 and 2521 are comprised of 1 bit. When the mode switches 2511 and 2521 are 0, they indicate the ASRS configuration mode 1, and when the mode switches 2511 and 2521 are 1, they may indicate an ASRS configuration mode 2. The mode switches 2511 and 2521 correspond to flags identifying the existing DCI format 0/1 A. Namely, the flags may serve as the mode switches 2511 and 2521. The reason is as follows.

If it is assumed that the DCI format 1A does not have the ASRS activation field, only the DCI format 0 includes the ASRS activation field. This means that only the DCI format 0 includes the ASRS activation field. Since the DCI format 0 is fixed to include the ASRS activation field, the existing flag identifying the DCI format 0/1 A is configured to be a redundant field. Thus, the flag may serve as the mode switches 2511 and 2521. In this case, the flag does not perform its function as a DCI format identifier. Thus, a code point not used as the function of the flag may be used for the purpose of discriminating the ASRS configuration mode.

The ASRS configuration modes 1 and 2 are different as follows. In the ASRS configuration mode 1, the ASRS configuration parameter is signaling of an upper layer. Thus, the DCI format 0 of type 2 and the ASRS configuration parameter are separated. In this case, the DCI format 0 of type 2 includes fields required for the role of an uplink grant as shown in Table 11.

Meanwhile, in the ASRS configuration mode 2, the ASRS configuration parameter is included in the DCI format 0. Namely, the DCI format of type and the ASRS configuration parameter are not separated. In this case, the DCI format 0 is a new DCI format having completely different characteristics from the uplink grant. The DCI format 0 of type 2 may be configured as shown in Table 13 below.

TABLE 13
mode switch provides ASRS configuration parameter
transmission mode-1 bit -SRS
Activation provides Interpretation of DCI format-1 bit
Transmission BW provides Four SRS BWs per operating BW -2 bits
Frequency Position provides Starting BW Position (3 bits
for <=5 MHz)-3 or 5 bits
Transmission Comb provides Eight cyclic shifts -3 bits
SRS Configuration Index ISRS - 9 bits
CRC (UE ID) provides UE ID masked in the CRC -16 bits

With reference to Table 11 and Table 13, when the mode switches 2511 and 2521 are 0, the DCI format is as shown in Table 1, and when the mode switches 2511 and 2521 are 1, the DCI format is as shown in Table 13.

In this manner, when the flag for discriminating the DCI format 0/1 A is used to discriminate the configuration parameter transmission mode of the aperiodic SRS, there is no limitation of an uplink transmission otherwise generated when a coding point with respect to the DCI format 0 is used, and the performance is not degraded.

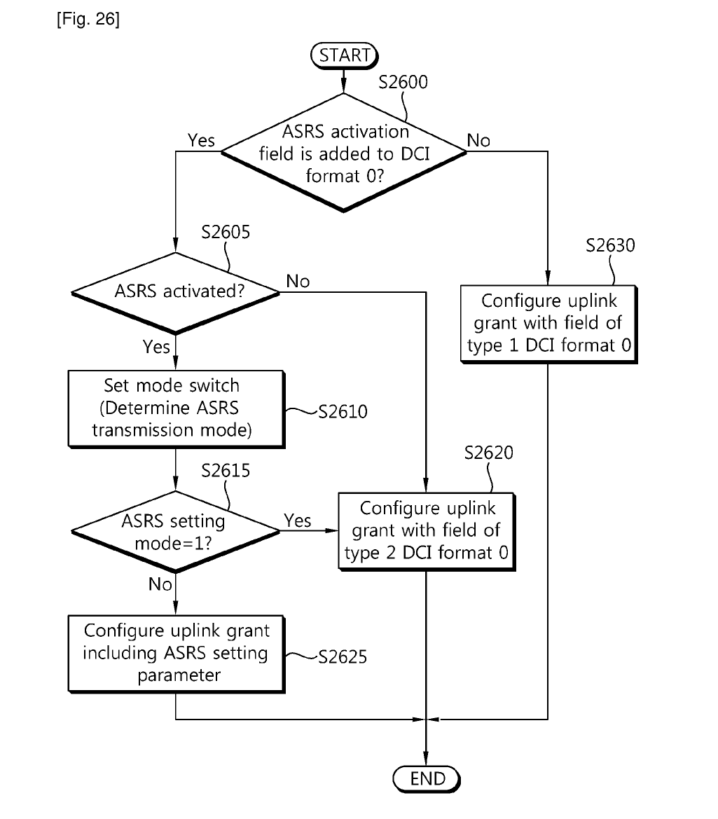

FIG. 26 is a how chart illustrating the process of a method for transmitting ASRS setting parameter by the BS according to an embodiment of the present disclosure. Hereinafter, the DCI format 0 will be described, but it is merely illustrative and any other DCI formats, e.g., a DCI format 4, which can constitute an uplink grant may be applicable.

With reference to FIG. 26, the BS determines whether to add the ASRS activation field to the DCI format 0 (S2600). The ASRS activation field may have 1 bit. If the BS does not add the ASRS activation field to the DCI format 0, the BS constitutes an uplink grant with the field of the DCI format 0 of type 1 as shown in Table 10 (S2630).

If the BS adds the ASRS activation field to the DCI format 0, the BS determines whether to activate the ASRS (S2605). In this case, the DCI format 0 belongs to type 2. The UE must know about whether the DCI format 0 is type 1 or type 2, and this is notified through signaling to an upper layer of the BS. The upper layer includes a layer, e.g., MAC or RRC, positioned at an upper position of a physical layer.

When the BS determines to deactivate the ASRS in step S2605, the BS constitutes an uplink grant with the field of the DCI format 0 of type 2 as shown in Table 11 (S2620). Meanwhile, when the BS determines to activate the ASRS, the BS configures a mode switch (S2610). The mode switch indicates whether or not the DCI format 0 includes the ASRS configuration parameter. In another aspect, the mode switch indicates whether or not the ASRS configuration parameter is given by upper layer signaling or whether or not the ASRS configuration parameter is included in the DCI. The configuration of the mode switch is immediately determining the ASRS configuration mode (or transmission mode). The mode switch may be the flat of the conventional DCI format 0.

The BS determines whether or not the mode switch has been set as an ASRS configuration mode 1 (S2615). For example, when the value of the mode switch is ‘0’, the ASRS configuration mode is 1, and when the value of the mode switch is ‘1’, the ASRS configuration mode 2. If the mode switch indicates the ASRS configuration mode 1, the BS constitutes an uplink grant with the field of the existing DCI format 0 (S2620). This is because, since the ASRS configuration parameter is performed by upper layer signaling, the DCI can perform the original function of the uplink grant.

If the mode switch indicates the ASRS configuration mode 2, the BS constitutes an uplink grant including the ASRS configuration parameter (S2625). In this case, the uplink grant may include the parameter fields as shown in Table 13.

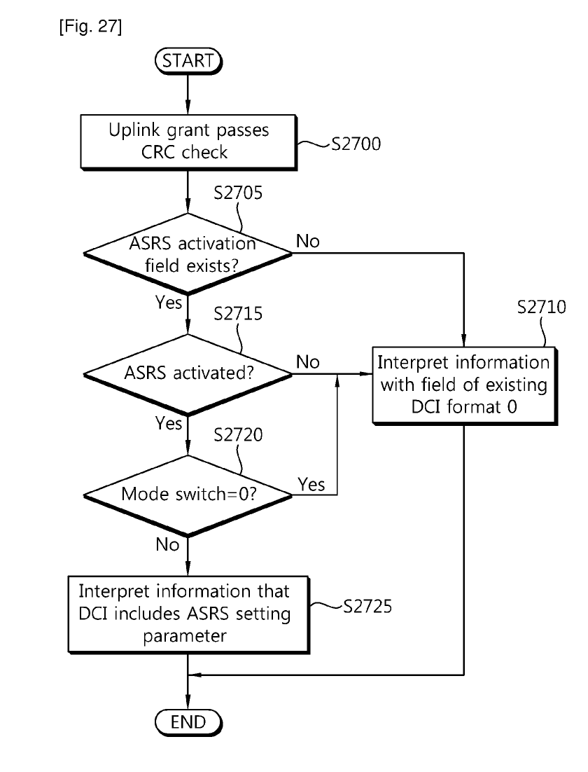

FIG. 27 is a how chart illustrating the process of a method for receiving an ASRS setting parameter by a terminal according to another embodiment of the present invention. Hereinafter, the DCI format 0 will be described, but it is merely illustrative and the present invention can be applicable to any DCI format, e.g., a DCI format 4, which is able to constitute an uplink grant.

With reference to FIG. 27, when an uplink grant is successfully decoded, the terminal allows for CRC checking to pass (S2700). The CRC checking may be performed by demasking a C-RNTI (Cell-Radio Network Temporary Identifier), a unique identifier of the terminal, on a CRC of the uplink grant.

The terminal determines whether or not an ASRS activation field exists within the uplink grant (S2705). When the ASRS activation field does not exist within the uplink grant, the uplink grant is the DCI format 0 of the conventional type 1. Thus, the terminal interprets information according to the field of the existing DCI format 0 (S2710).

If the ASRS activation field exists within the uplink grant, the terminal determines whether or not an ASRS is activated (S2715). The uplink grant is a DCI format 0 of type 2. Namely, the uplink grant additionally includes 1 bit compared with the DCI format 0 of type 1. Whether or not the ASRS is activated can be known by checking whether or not the ASRS activation field is 0 or 1.

When the ASRS is deactivated, the terminal interprets the information according to the field of the existing DCI format 0 (S2710).

When the ASRS is activated, the terminal determines whether or not a mode switch within the uplink grant is 0 (S2720). When the mode switch is 0, it can be noted that an ASRS configuration parameter is transmitted based on an ASRS configuration mode 1. Namely, the ASRS configuration parameter is transmitted according to upper layer signaling. The uplink grant includes the field which performs the original function as it is. Thus, the terminal interprets the information according to the field of the existing DCI format 0 (S2710).

When the mode switch is 1 in step S2720, it can be noted that the ASRS configuration parameter is transmitted based on an ASRS configuration mode 2. Namely, the ASRS configuration parameter is included in the uplink grant and transmitted. Thus, the terminal interprets the information on the assumption that the DCI includes the ASRS configuration parameter (S2725).

In the above description, although all the components constituting an embodiment of the present invention are combined or coupled to operated, the present invention is not necessarily limited thereto. Namely, all the components may be selectively coupled to operate within the scope of the present invention. Also, all the components may be implemented as single independent hardware, respectively, or a portion or the entirety of the components may be selectively combined to be implemented as a computer program having a program module performing the function of a portion or the entirety of one or a combination of a plurality of hardware. The codes or code segments constituting the computer program can be easily derived by a person skilled in the art. The computer program is stored in a computer-readable medium and read and executed by a computer to implement an embodiment of the present invention. The storage medium of the computer program may include a magnetic recording medium, an optical recording medium, a carrier wave medium, and the like.

An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

The preferred embodiments of the present invention have been described with reference to the accompanying drawings, and it will be apparent to those skilled in the art that various modifications and variations can be made in the present invention without departing from the scope of the invention. Thus, it is intended that any future modifications of the embodiments of the present invention will come within the scope of the appended claims and their equivalents.

1. A method for transmitting resource allocation information for an aperiodic transmission of a sounding reference signal (SRS), the method comprising:
determining, by a base station (BS), resource to be allocated for a transmission of an aperiodic SRS to a user equipment (UE) to which an aperiodic SRS is to be transmitted;
transmitting indication information regarding the determined resource by using extra information of a physical control channel; and
receiving an aperiodic SRS transmitted by the UE in the determined resource after the transmission of the physical control channel.

2. The method of claim 1, wherein the indication information is information regarding a starting position of the resource and information regarding a bandwidth of the resource.

3. The method of claim 1, wherein the physical control channel is a physical downlink control channel (PDCCH), and the extra information is within a range not used in a field for an uplink resource allocation in a format 0 of the PDCCH.

4. The method of claim 1, wherein the physical control channel is a physical downlink control channel (PDCCH), and the extra information is within a range not used in a field for an downlink resource allocation in a format 1A of the PDCCH.

5. A method for receiving resource allocation information for an aperiodic transmission of a sounding reference signal (SRS), the method comprising:
receiving, by a user equipment (UE), a physical control channel from a base station (BS);
checking whether information of the received physical control channel is extra information;
converting the information of the physical control channel into indication information indicating resource to be allocated for a transmission of an aperiodic SRS, when the information of the control channel is extra information; and
transmitting an aperiodic SRS by using the indication information.

6. The method of claim 5, wherein the indication information is information regarding a starting position of the resource and information regarding a bandwidth of the resource.

7. The method of claim 5, wherein the physical control channel is a physical downlink control channel (PDCCH), and the extra information is within a range not used in a field for an uplink resource allocation in a format 0 of the PDCCH.

8. The method of claim 5, wherein the physical control channel is a physical downlink control channel (PDCCH), and the extra information is within a range not used in a field for an downlink resource allocation in a format 1A of the PDCCH.

9. An apparatus for receiving resource allocation information for an aperiodic transmission of a sounding reference signal (SRS), the apparatus comprising:
a transceiver unit configured to receive radio signal including a physical control channel from a base station (BS) and transmit an SRS;
an indication information extracting unit configured to check whether information of the received physical control channel is extra information, and convert the information of the physical control channel into indication information indicating resource to be allocated for a transmission of an aperiodic SRS when the information of the control channel is extra information; and
an SRS generating unit configured to generate an aperiodic SRS by using the indication information.

10. The apparatus of claim 9, wherein the indication information is information regarding a starting position of the resource and information regarding a bandwidth of the resource.

11. The apparatus of claim 9, wherein the physical control channel is a physical downlink control channel (PDCCH), and the extra information is within a range not used in a field for an uplink resource allocation in a format 0 of the PDCCH.

12. The apparatus of claim 9, wherein the physical control channel is a physical downlink control channel (PDCCH), and the extra information is within a range not used in a field for an downlink resource allocation in a format 1A of the PDCCH.

13. An apparatus for transmitting resource allocation and period information for an aperiodic transmission of a sounding reference signal (SRS), the apparatus comprising:
a determining unit configured to determine resource and a period to be allocated for a transmission of an aperiodic SRS to a user equipment (UE) to which a base station (BS) is to transmit an aperiodic SRS; an indication information generating unit configured to generate indication information indicating the determined resource and period;
a coding unit configured to generate a radio signal by including the indication information in a physical control channel; and
a transceiver unit configured to transmit the radio signal to the UE and receive an aperiodic SRS transmitted by the UE by repeating the determined period in the determined resource.

14. The apparatus of claim 13, wherein the indication information is information regarding a starting position of the resource and information regarding a bandwidth of the resource.

15. The apparatus of claim 13, wherein the physical control channel is a physical downlink control channel (PDCCH), and the extra information is within a range not used in a field for an uplink resource allocation in a format 0 of the PDCCH.

16. The apparatus of claim 13, wherein the physical control channel is a physical downlink control channel (PDCCH), and the extra information is within a range not used in a field for an downlink resource allocation in a format 1A of the PDCCH.
